(19) United States
(12) Patent Application Publication
(10) Pub. No.: US 2006/0155645 A1
(43) Pub. Date: Jul. 13, 2006

(54) Image uploading and print-on demand system and method, namely for art and photographs

(75) Inventors: Kya Driver Sainsbury-Carter, Raleigh, NC (US); Michael John Marston, Raleigh, NC (US); Thomas Daniel Kuppinen, Raleigh, NC (US)

Correspondence Address: WITHROW & TERRANOVA, P.L.L.C., P.O. BOX 1287, CARY, NC, 27512, US

(73) Assignee: ART.COM, INC., Raleigh, NC (US)

(21) Appl. No.: 11/032,542

(22) Filed: Jan. 10, 2005

(51) Int. Cl. G06Q 40/00

(52) U.S. Cl. 705/44; 705/35

(57) ABSTRACT

A computer system and method allowing a user to upload an image representing artwork into the memory of the computer system. Thereafter, after the image is uploaded and approved, the image can be made available for display to other users of the computer system and made available for sale as an original artwork, or sale as a reproduction using a print-on-demand (POD) process. In one embodiment, the computer system is a retail website that displays and sells images, such as posters, photographs, and artwork. The user is an artist who desires to upload their artwork to the computer system for inclusion in the artist's portfolio that is electronically stored by the computer system. Once the artwork is uploaded by the artist and approved, the artwork can is displayed to other users of the computer system and/or made available for sale using POD if selected by the artist and approved.

### FIELD OF THE INVENTION

The present invention relates to an electronic image uploading and print-on-demand system and method, namely for art and photographs, that allows uploading and registration of electronic images into a portfolio and selection of images in the portfolio for print-on-demand offering on a computer system, such as a retail website.

### BACKGROUND OF THE INVENTION

With the advent of electronic imaging, it is commonplace for images to be converted from an analog to digital format. For example, electronic images may be photographs or artwork that are converted into digital images and stored in computer memory. One example of this is a digital camera that is able to take photographs and store the pictures in a digital format. Once the images are in digital format, the images can be easily transferred between computers or displayed and manipulated on computer systems as desired.

Because of the relative ease in converting images into a digital format and because of the advent of the Internet and web browsers, it is common for digital images to be displayed on web pages for commercial and non-commercial reasons. For example, at the retail website http://www.art.com (hereinafter the “Art.com website”), posters and other artwork are displayed in a digital format for sale to consumers. This artwork may be high volume reproductions, limited high quality reproductions of original artwork by artists, or the original artwork itself. In this manner, the customer is able to visually see the poster or artwork desired on the Art.com website before making a purchase. Art.com keeps an inventory of posters and artwork on hand to deliver to the customer in response to a purchase.

After a purchase is made by a consumer on the Art.com website, Art.com's supply-chain system selects the proper item from inventory, and the item is sent to the customer. As one can imagine, there are several limitations to this system. First, Art.com must keep an inventory of all available posters and artwork on hand to fulfill orders thereby adding to overhead costs in terms of storing and maintaining an inventory. Further, complicated estimates must be tracked and made of inventories based on customer demand for products in order to maintain a proper amount of inventory on hand to fulfill customer demand.

Further, in the case of original artwork reproductions, if it were not for the present invention as discussed below, Art.com would have to manually arrange with artists to determine which artists' artwork would be made available for sale on the Art.com website. Thereafter, the artist must arrange to have the original artwork reproduced via a separate production company and order quantities sufficient for Art.com to keep on hand. Art.com must arrange to receive the reproduction quantities to keep on hand. As one can imagine, with a system for selling original artwork reproductions using this method, both the cost as well as the ability to keep inventory on hand will severely limit both the number of artists' artwork that can be sold as high quality reproductions that can be offered and kept on hand for sale.

Another technology has come about that alleviates the need to keep inventory of images on hand called “print-on-demand” (POD). POD is speed optimized print production with high resolution capability for high quality reproductions of original images that have been digitized. With POD, speed printers are able to print high quality digitized images, such as artwork, as needed and on demand without significant delay. This avoids the expense involved in maintaining high inventory levels, as the images desired to be reproduced are only produced as needed. In the case of Art.com, original artwork reproductions could be produced using POD so that larger inventories are not required and so that more artists' original artwork reproductions can be offered for sale on the Art.com website.

However, even if the POD technology is offered for original artwork reproductions available on the Art.com website, there still exists a need for an artist to, in an automated manner, upload images for registration in a portfolio, and then selectively choose which images will be made available for POD. This gives the artist greater flexibility and control over which artwork will be sold as reproductions. The present invention solves this problem by providing a system and method for allowing artists to register for uploading images, including original artwork, for registration and inclusion into portfolios as well as selection for a POD process. If the original artwork is uploaded and approved for POD, the original artwork, once reproduced, is made available for sale as an original artwork reproduction attributed to the artist.

### SUMMARY OF THE INVENTION

The present invention involves a computer system and method, including those that execute websites, allowing the ability for a user to upload and register an image into the memory of the computer system. Thereafter, after the image is uploaded and approved, the image is made available for display to other users of the computer system and made available for sale as an original artwork, or sale as a reproduction using print-on-demand (POD).

In the preferred embodiment, the computer system is a retail website, and more particularly the website http://www.art.com (the “Art.com website”), that displays and sells images, such as posters, photographs, and artwork. The uploaded image is an image of photography or artwork. The user is an artist who desires to upload his or her artwork to the computer system for inclusion in the artist's portfolio that is electronically stored by the computer system. Once the artwork is uploaded by the artist, the artwork can be approved to be displayed to other users of the Art.com website. Other users can choose to purchase the original artwork directly from the artist, or a high-quality reproduction of the artwork, if the artist has previously made a POD order for the artwork and such has been approved, which is the subject matter of the present application.

Before an artist can upload artwork to the website to his or her portfolio, the artist must apply for an artist account. When the artist applies for an account, memory is allocated to allow the artist to upload images in to his or her specific portfolio on the website. After the artist is registered and the artwork is uploaded and approved, the artist can choose one or more pieces of their artwork to be sold through the retail website to other users as originals, or as reproductions using a print-on-demand (POD) process. A POD process allows images to be printed after being ordered rather than fulfilling such order with on hand inventory. The present application focuses on artwork that is selected for sale as reproductions using POD.

The present invention is not limited to retail websites that sell artwork, although the illustrative embodiment of the present invention described in this application is with respect to Art.com's retail website http://www.art.com. The present invention is applicable to any computer system that allows users to access and upload images to such system, and in which the images can be selected for POD when ordered or purchased by other users of the computer system.

In order for an artist to access the computer system or website, the artist interacts with a computer, such as a typical desktop personal computer (PC). The computer includes a display that typically runs an Internet browser to display information received over the Internet and sends information out over the Internet. The computer is coupled to the Internet via a communication link or communications network to accomplish data packet transfer using hypertext transfer protocol (HTTP) as is well known by those of ordinary skill in the art. Messages sent by the computer over the Internet that are destined for the computer system's IP address are received to the computer system.

Once the artist registers on the website, their member ID and their chosen password are stored. When the artist reenters the website and requests to login to his or her account, the computer system compares the entered member ID and password with the list of member IDs and passwords. If there is a match, the computer system is aware that artist has previously registered and is a member.

If a registered artist decides to upload artwork to the Art.com website for storage in memory in the artist's portfolio, the uploaded artwork is stored in memory. Once an artist has uploaded artwork, the website creates stores the uploaded artwork in memory. If the uploaded artwork has not been approved, it is not made available to other users of the website. Once the artwork is approved, an approval status field for the artwork entry is updated in memory, and the artwork can be selected for POD order.

If an uploaded artwork is selected for POD order, the website creates a POD order and stores the POD order in memory. The POD order is associated with the member/artist who placed the order. If a POD order is submitted and approved, meaning that an uploaded artwork by an artist/member was approved for POD order, the computer system creates an entry for the order in memory so that a reproduction of the artwork can be purchased by users of the Art.com website. Thereafter, any order made by other users for a reproduction of the uploaded artwork that has been selected for POD and approved, will receive a reproduction created by a POD system. In this manner, the order fulfillment center associated with the website does not have to keep inventory on hand of the artwork selected for POD to fulfill orders thereby reducing costs and expense.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIGS. 1A and 1B are an illustration of an example of a home page on the Art.com website as an example of a retail website that displays digitized images for sale as posters and artwork;

FIG. 2 is an illustration of the communication and system architecture of the Art.com system;

FIG. 3 is an illustration of the software database architecture for the original artwork productions (OAP) system;

FIGS. 4A and 4B are a flowchart illustration of the steps performed by the Art.com system in accordance with the present invention for uploading, registering, and selecting an image for POD, and the image being approved for offer for sale to customers on the Art.com websites as an original artwork reproduction;

FIGS. 5A and 5B are a flowchart illustration of the steps in order for an artist to join the original art and photography (OAP) program on the Art.com website so that the artist can upload images to a portfolio maintained for the artist on the Art.com system;

FIGS. 6A and 6B are an illustration of a page displayed as a result of an artist selecting the OAP tab on the Art.com website;

FIGS. 7A and 7B are an illustration of a page displayed as a result of an artist selecting to join OAP from the page displayed in FIGS. 6A and 6B;

FIGS. 8A and 8B are an illustration of a page displayed as a result of an artist selecting to join OAP from the page displayed in FIG. 7 for the artist to enter name, email, and password information;

FIGS. 9A and 9B are an illustration of a page displayed as a result of an artist submitting account information from the page displayed in FIG. 8 so that the artist can enter address and payment information to join OAP;

FIG. 10 is a flowchart illustration of a flowchart of the steps performed by the Art.com system when an artist chooses to login to his or her OAP account after an OAP account has been established for the artist by the Art.com system;

FIG. 11 is an illustration of a page displayed as a result of an artist selecting to login to his or her OAP account on the Art.com system;

FIGS. 12A and 12B are an illustration of a studio home page displayed as a result of an artist successfully logging in to his or her OAP account on the Art.com system;

FIGS. 13A and 13B are a flowchart illustration of the steps performed by the Art.com system to allow an artist to upload an image into his or her portfolio on the Art.com system and to enter information about the uploaded image;

FIGS. 14A and 14B are an illustration of a page displayed as a result of an artist selecting the “Manage Account” tab in the artist's studio;

FIG. 15 is an illustration of page displayed as a result of an artist choosing to upload an image to be placed into this artist's portfolio on the Art.com system;

FIGS. 16A and 16B are an illustration of a page displayed as a result of the artist uploading an image so that information about the uploaded image can be entered by the artist;

FIGS. 17A and 17B are an illustration of a page that displays images uploaded by an artist to his or her portfolio and the status of each uploaded image;

FIG. 18 is a flowchart illustration of the process for an artist to modify the icon of an uploaded image that has been approved for display in the artist's portfolio and on the Art.com system for selection by a user;

FIGS. 19A and 19B are an illustration of a page that displays images uploaded in an artist's portfolio that have been approved as a result of the artist selecting the “Artwork Appearance” link;

FIGS. 20A and 20B are an illustration of a page that is displayed as a result of an artist selecting an uploaded image to select the icon for the image;

FIGS. 21A and 21B are an illustration of a page that is displayed as a result of an artist selecting an icon for an uploaded image;

FIGS. 22A-22D are a flowchart illustration of an artist selecting an uploaded image for POD;

FIGS. 23A and 23B are an illustration of a page that is displayed as a result of an artist selecting the “POD Setup” link;

FIGS. 24A and 24B are an illustration of a page that displays the terms and conditions of POD for an artist to agree to as part of the POD setup process;

FIGS. 25A and 25B are an illustration of a page that is displayed as a result of the artist accepting the terms and conditions of the POD setup process to them select an image from his or her portfolio for POD;

FIGS. 26A-26C are an illustration of a page that is displayed to allow an artist to select a “POD Prep Package” for an uploaded image selected for POD;

FIGS. 27A and 27B are an illustration of a page that is displayed to allow an artist to select the substrate for the uploaded image selected for POD;

FIGS. 28A and 28B are an illustration of a page that is displayed to allow an artist to select a proofing package for the uploaded image selected for POD;

FIGS. 29A-29C are an illustration of a page that is displayed to allow an artist to review and confirm a POD order for the uploaded image selected for POD;

FIGS. 30A and 30B are an illustration of a page that is displayed to confirm the order for the uploaded image selected for POD;

FIG. 31 is an illustration of a record that is created in the Art.com system memory for an uploaded image selected for POD and confirmed by the artist; and

FIGS. 32A-32C are an illustration of an email that is sent by the Art.com system to the artist's email address when the uploaded image selected by the artist is approved by the Art.com system wherein the artist is instructed on how to submit the original artwork for POD reproduction setup.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention involves a computer system, including those that execute websites, allowing the ability for a user to upload and register an image into the memory of the computer system. Thereafter, after the image is uploaded and approved, the image can be made available for display to other users of the computer system and made available for sale as an original artwork, or sale as a reproduction using print-on-demand (POD), as discussed in more detail in this application.

In the preferred embodiment, the computer system is a retail website that displays and sells images, such as posters, photographs, and artwork. The uploaded image is an image of photography or artwork (hereinafter referred to collectively as “artwork”). The user is an artist who desires to upload his or her artwork to the computer system for inclusion in the artist's portfolio that is electronically stored by the computer system. Once the artwork is uploaded by the artist, the artwork can be approved to be displayed to other users of the computer system.

An artist must apply for and register an account on the retail website before being able to upload images into his or her portfolio. After the artist is registered and the artwork is uploaded and approved, the artist can choose one or more pieces of their artwork to be sold through the retail website to other users as originals, or as reproductions using a print-on-demand (POD) process. A POD process allows images to be printed on demand after being ordered rather than fulfilling such order with on hand inventory. The present application focuses on artwork that is selected for sale as reproductions using POD. These basic aspects of the present invention are described below in more detail.

Note that the present invention is not limited to a particular type of computer system that sells artwork, although the illustrative embodiment of the present invention described below in this patent application is with respect to Art.com's retail website http://www.art.com. The present invention is applicable to any computer system or website that allows users to access and upload images to such system, and in which some or all of such images can be selected for POD when ordered or purchased by other users of the computer system.

The application below describes the present invention using an exemplary embodiment of Art.com's retail website at http://www.art.com (hereinafter the “Art.com website”). However, the present invention is applicable to any computer system or website. The invention is described below in this application as a chronological progression of a user encountering and interacting with the Art.com website and the responses and tasks carried out by the Art.com website in response for any artist to apply for an account, upload images of artwork, the images being approved, and the images being selected for POD.

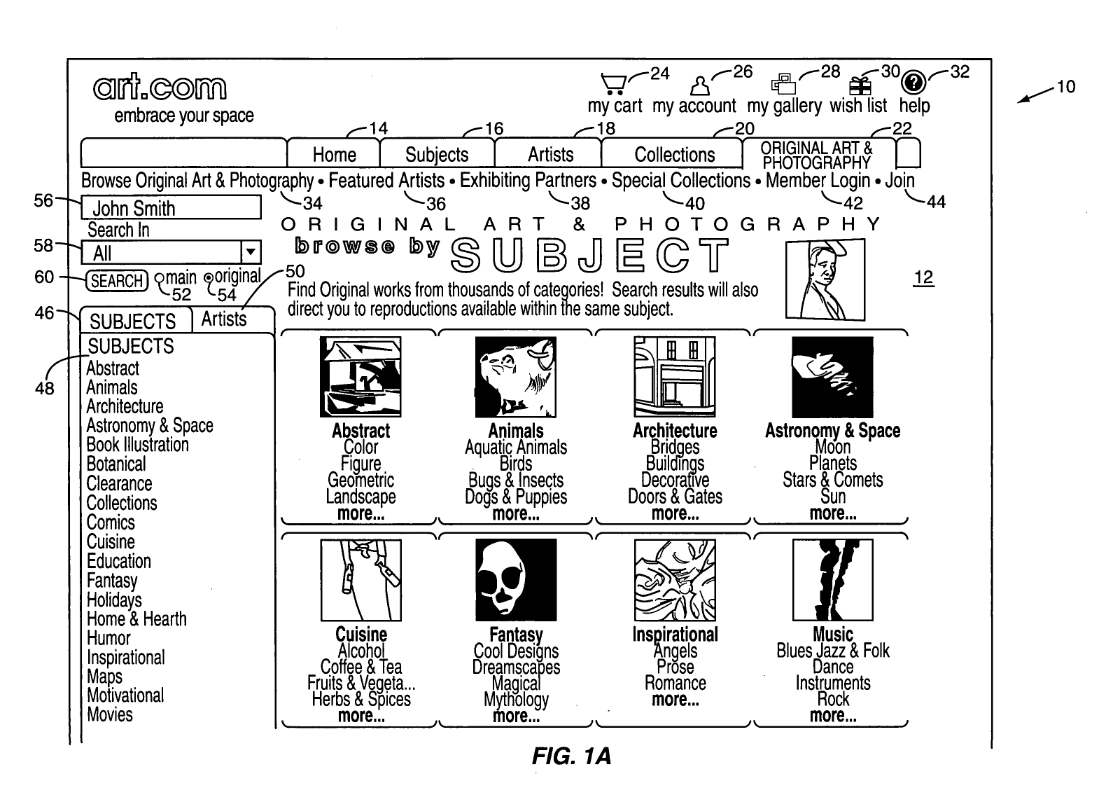

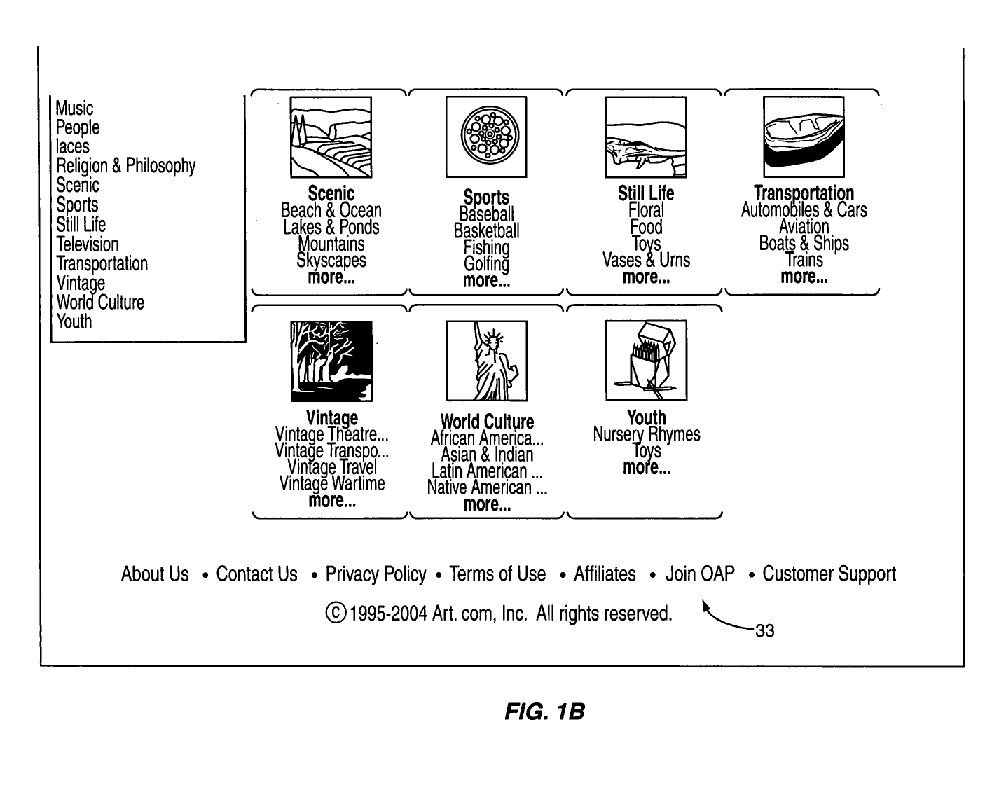

FIGS. 1A and 1B illustrate the homepage 10 of the Art.com website (www.art.com) with the “Original Art and Photography” section having been selected by the artist. FIGS. 1A and 1B illustrate one page on the Art.com website, but the page is split between FIGS. 1A and 1B in order to have enough space to show the entire page in the illustrations. Other illustrations in this application follow the same format.

For the purposes of this application, an “artist” is also a user. The home page 10 is comprised of page 12, which consists of tabs that allow a user to access various portions of the website. The “Home” tab 14 allows a user to access the home page of the Art.com website by clicking on the tab. The “Subjects” tab 16 is selected by a user to cause the Art.com website to display artwork available for viewing and/or sale by subject matter. Similarly, the “Artists” tab 18 can be selected by a user to cause the Art.com website to display artwork or other images available for purchase by artist name. The “Collections” tab 20 allows a user to select the organization of artwork and other images for display and purchase according to their designated collection, since some artwork on the Art.com website may have been uploaded and/or registered as part of a larger named collection.

The “Original Art & Photography” tab 22 is available to allow a user to access the “Original Art & Photography” (OAP) section of the Art.com website. FIG. 1A illustrates the OAP tab 22 as having been selected for the page 12. The OAP section of the Art.com website allows a user to access original artwork and photography both for display and purchase, as well as allowing artists desiring to upload and register their own original artwork and photographs with OAP, as will be described later in this application. It is the OAP section of the Art.com website that is particularly relevant to this exemplary embodiment of the present invention.

Before describing OAP, there are also additional functionalities worthy of note on the Art.com website that are also illustrated and FIGS. 1A and 1B. A user desiring to purchase artwork on the Art.com website can add such artwork to their shopping cart for subsequent purchase. If the user wishes to access his or her shopping cart, the user can select the “my cart” link 24 illustrated in FIG. 1 A. The user can also access a page on the Art.com website containing information about their account by selecting the “my account” link 26 since users can register themselves on the Art.com website in order to make purchases or perform other actions.

Also, as discussed in co-pending patent application Ser. No. 10/860,932 entitled “Sorting and filtering techniques for products, namely posters and artwork,” filed on Jun. 4, 2004, and incorporated herein by reference in its entirety, the user can access his or her gallery or wish list by selecting the “my gallery” link 28 or the “wish list” link 30 to access artwork added to the user's gallery or their wish list. A user can also click on the “help” link 32 to cause the Art.com website to display a page with instructional assistance.

As illustrated in FIGS. 1A and 1B, the user of the Art.com website can also search for artwork using a text search by entering text in the “Search In” text box 56. The user can further limit the search to categories by selecting categories in the category drop down menu 58. The user can also determine whether he or she wants to search in the main section of the Art.com website that contains artwork that is not original artwork by selecting the “main” button 52, or may choose to limit his or her search to the OAP section of the Art.com website by selecting the “original” button 54. Once the search criteria is entered in the “Search In” text box 56 and the category for the search is selected in the category drop down menu 58, the user can click the “SEARCH” button 60 to initiate the search in which the results of the search will be displayed in the page area 12 of the web page 10. The user can also select to search artwork by “Subjects” or by “Artists” by selecting either the “Subjects” tab 46 or the “Artists” tab 50. An example of the various subjects that are available for searching in the example of the Art.com website illustrated in FIGS. 1A and 1B is shown in “Subjects” menu 48.

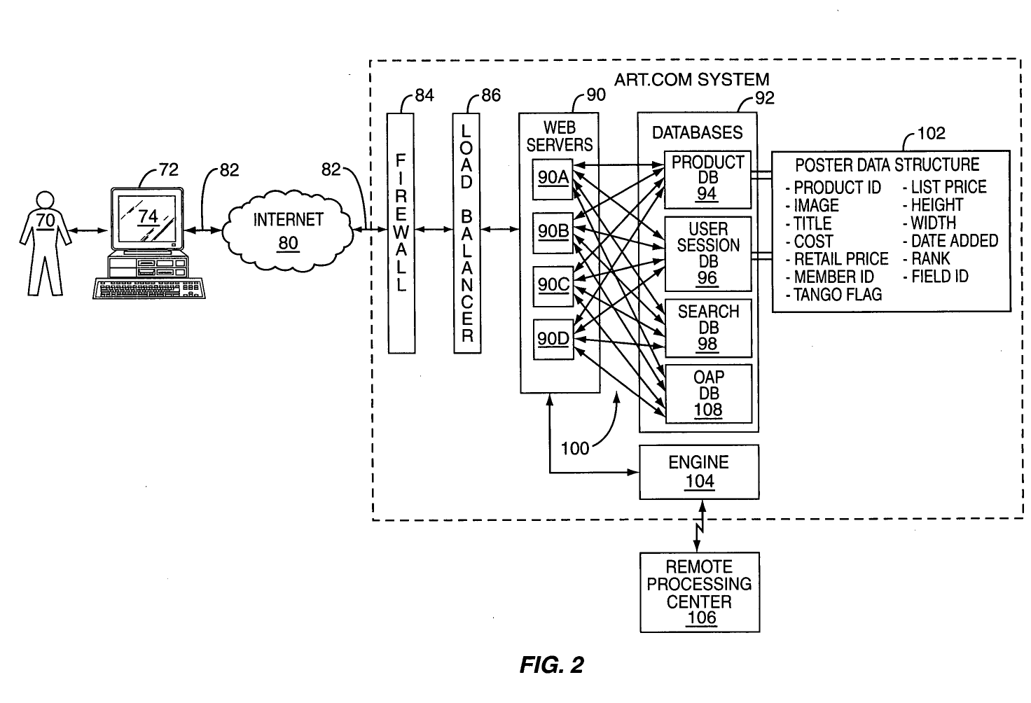

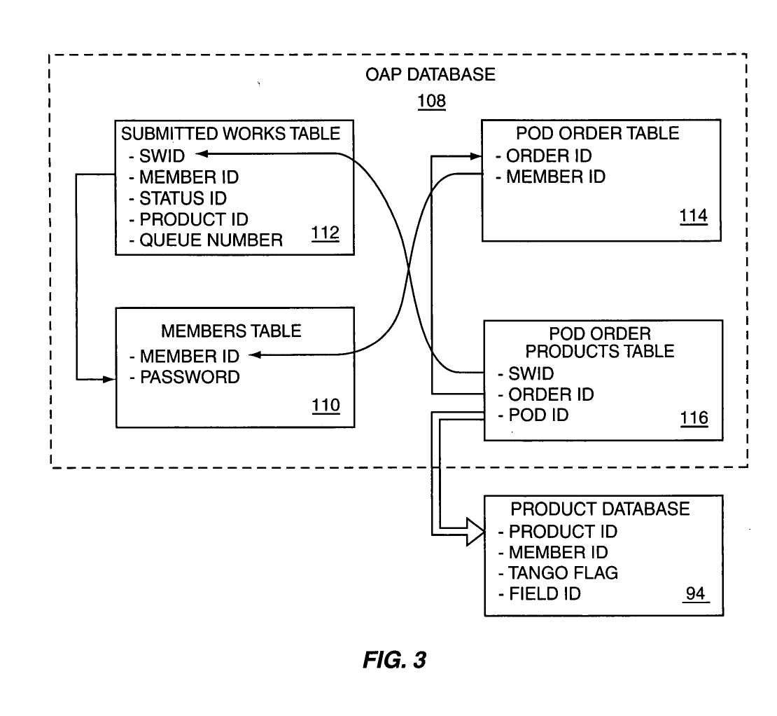

On the page 12 illustrated in FIGS. 1A and 1B, the user has selected the OAP tab 22 to access the OAP section of the Art.com website. In this section of the website, and as will be described further below, an artist can register and upload his or her own original artwork for display on the Art.com website. An artist can also select their uploaded original artwork to be made available for display to other users of the Art.com website as well as available for purchase of reproductions using POD as will be described below. Before describing the OAP functionality of the Art.com website, the architecture and database organization of the Art.com system and website are described and illustrated in FIGS. 2 and 3. Art.com Website Architecture

FIG. 2 illustrates the system and communication architecture of the Art.com system, also called “Art.com website,” whereby a user or artist 70 can access the Art.com website via the Internet to conduct transactions. As illustrated in FIG. 2, a user 70 interacts with a computing device or computer 72. The computer 72 includes a display 74 that typically runs an Internet browser to display information received over the Internet 80 and sends information out over the Internet 80. The computer 72 is coupled to the Internet 80 via a communication link or communications network 82 to accomplish data packet transfer using hypertext transfer protocol (HTTP) as is well known by those of ordinary skill in the art. Messages sent by the computer 72 over the Internet 80 that are destined for the Art.com IP address are received by the Art.com system as illustrated in FIG. 2.

A data packet sent by the computer 72 that is received by the Art.com system first encounters a firewall 84 to provide security and limited access into the Art.com system from the Internet 80. The data packet is next communicated to a load balancer 86 that then directs the message to one of a plurality of redundant web servers 90. In FIG. 2, four web servers are shown, web servers 90A, 90B, 90C, 90D. In this manner, the Art.com system has sufficient computing power to handle traffic from a plurality of computers 72 simultaneously. The web servers 90 are coupled with various databases 92 that are part of the Art.com website and system.

The databases 92 in the Art.com system include a product database 74, a user session database 96, a search database 98, and an OAP database 108. The web servers 90 are communicatively coupled to these databases 92 via communication links 100. Communication links 100 are provided between every web server 90 and every database 92 so that each web server 90 is able to communicate with any database 92 for operation of the system. The web servers 90 contain the logic that generates the web pages sent by the Art.com system to the user 70 over the Internet 80. The web servers 90 access the databases 92 to retrieve information about artwork which is available for display and ordering by the user 70 via the Art.com system. This Art.com system is responsible for generation of the Art.com website on the user's 70 computer 74.

The user session database 96 is used to store an instance of an ongoing session established by the user 70 with the web server 90, such as when a customer logs into the Art.com website using his or her account name and password. The product database 94 contains information about each piece of artwork that is available to be displayed and purchased by the user 70 via interaction with a web server 90. The search database 98 contains cached search results based on the search request made by the web servers 90 to the product database 94. The web servers 90 check the search database 98 in response to a search request to determine if the search request desired is already stored in the search database 98. In this manner, the web server 90 is able to more quickly execute search requests by the user.

Within both the product database 94 and the search database 98 are contained poster data structures 102 that contain vital information about each piece of artwork available for display and purchase by the user 70 via interaction with the Art.com system. The poster data structure 102 is also used to perform the various sorting and filtering techniques that are part of the present invention as well. The poster data structure 102 includes a product ID for the poster that is used to uniquely store each artwork that is available for purchase in the databases 92. The poster data structure 102 also contains an image file name that is a file containing a representative graphic image of the artwork sent to the user's 70 computer 74 for display. The poster data structure 102 also contains a title, cost, retail price and list price of a poster to be used by the web server 90 for various operations of the Art.com system. The poster data structure 102 also includes the height and width of the poster for sorting based on the height and width of the poster.

The poster data structure 102 also includes the date that the artwork was added to the Art.com system and made available for access by a user 70 as well as a rank field that is indicative of which posters are ordered more often by users 70. The web server 90 is also coupled to an engine 104 that directs messages from the Art.com system to a remote processing center 106 for payment. The remote processing center 106 is used for processing of credit card accounts so that the user 70 can use his or her credit card account for purchasing artwork. The user's 70 account information is transmitted to the engine 104 and then to the remote processing center 106 to charge a user's 70 account for purchase of artwork.

The OAP database 108 contains information tables regarding artists having accounts in OAP and information relating to uploaded and registered artwork. A separate database was created for OAP since information about artists who register for OAP is kept separately from other information in the system. If uploaded artwork is eventually made available for viewing and/or for purchase as an original or reproduction using POD, as described in this application, the information on the artwork will be made available to the product database 94 so that users can purchase reproductions of the artwork. The OAP database 108 is described in more detail below and is illustrated in FIG. 3.

FIG. 3 illustrates the architecture of the OAP database 108. The OAP database 108 is comprised of memory that contains memory tables. The first table is a “members table” 110. The “members table” 110 contains a list of all artist identifications (IDs) that are registered for OAP. Once the artist registers for OAP, their member ID and their chosen password are stored by the Art.com system in the “members table” 110 for later access. When the artist enters into the OAP section of the Art.com website, as will be discussed in this application, the Art.com system compares the entered member ID and password with the list of member IDs and passwords in the “members table” 110. If there is a match, the artist has previously registered for OAP and is a member, and is allowed to access the OAP sections of the Art.com website. Memory is also made available for the artist to upload artwork images to be stored in the artist's portfolio.

If an artist who is a member of OAP decides to upload artwork to the Art.com website for storage in memory in the artist's portfolio, the uploaded artwork is stored in the “submitted works table” 112. Once an artist has uploaded artwork, the Art.com system creates an entry into the “submitted works table” 112 with the following entries made. The artwork is given a submitted works ID (SWID), the member ID who submitted the work is stored for the SWID, a “Status ID” field is created, a “Product ID” field is created, and a “Queue Number” is created. The “Status ID” stores the approval status of the uploaded artwork, as will be described later in this application. The “submitted works table” 112 contains a link into the “members table” 110 to access the member IDs to use assign a member ID to artwork stored in the “submitted works table” 112.

If the uploaded artwork has not been approved, it is not made available to other users of the Art.com website, and a “Product ID” is not created. Only artwork that is approved is made available for display and/or purchase through the Art.com website and is assigned a “Product ID” to be stored in the product database 94. The “Queue Number” is the number in a queue in memory that is used to determine whether the uploaded artwork is approved for access to other users on the Art.com website. If the artwork is approved, an approval status is stored in the “Status ID” field for the artwork entry in the “submitted works table” 112, and the artwork can be selected for POD order.

If an uploaded artwork is selected for POD order, as will be described later in this application, the Art.com system creates a POD order and stores the “POD order” in a “POD Order Table” 114. The POD order is stored with an “Order ID” and is stored associated with the member/artist who placed the order. The Art.com system also creates a “POD Order Products Table” 114. The “POD Order Products Table” 116 contains an entry for each artwork submitted for POD order. The “POD Order Products Table” 116 contains a link into the “submitted works table” 112 to access the “SWID” for the artwork. An “Order ID” and “POD ID” are assigned to the POD order.

If a POD order is submitted and approved, meaning that an uploaded artwork by an artist/member was approved for order, the Art.com system thereafter creates an entry for the order into the products database 94 in which a “Product ID” is assigned, so that a reproduction of the artwork can be purchased by users of the Art.com website. A “Tango Flag” is set indicating that the artwork for the “Product ID” is a reproduction using POD rather than a product in which inventory is kept on hand.

Now that a description of the architecture and databases of the Art.com system that executes the Art.com website has been provided, this application next describes the chronological steps for an artist to access OAP, upload artwork, and select artwork for POD.

Overall Process

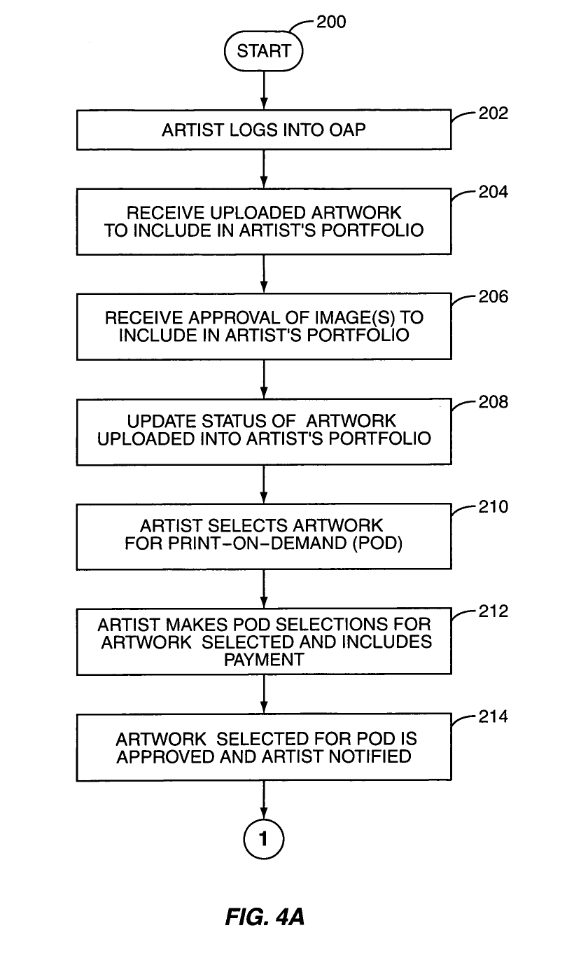

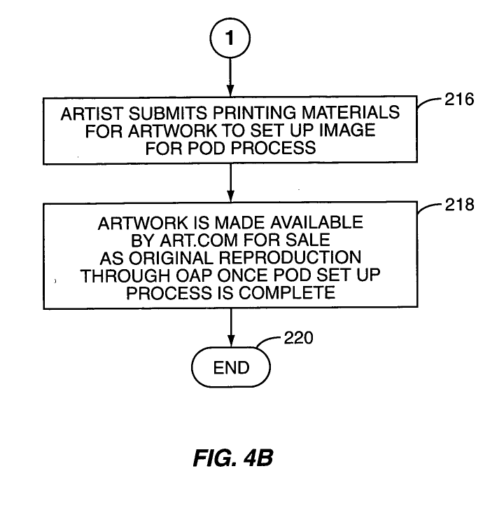

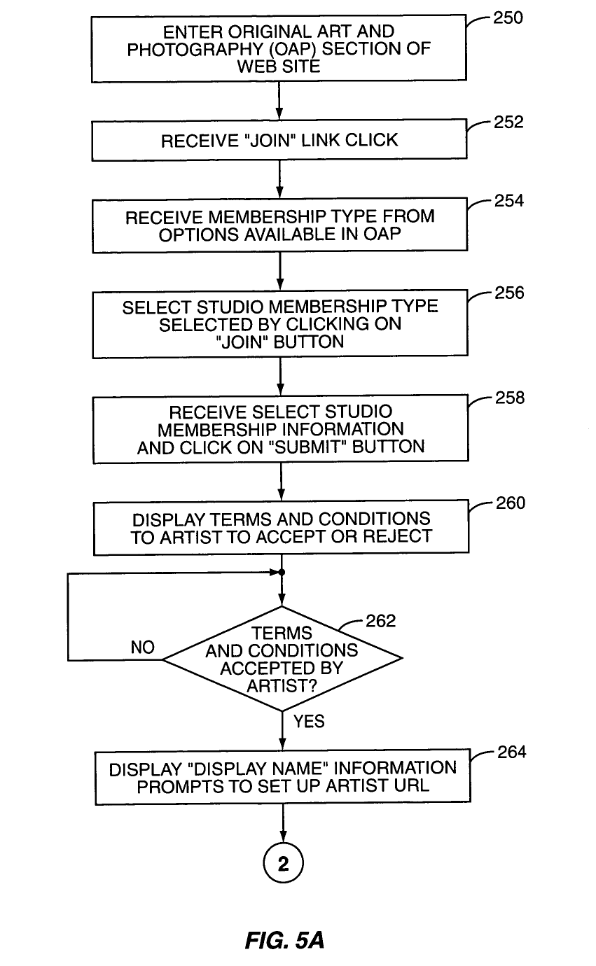

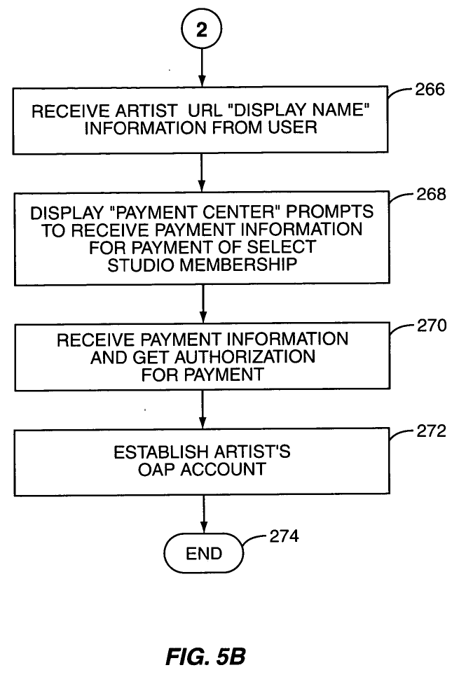

The overall process for an artist uploading artwork and selecting artwork for POD is set forth in the flowcharts of FIGS. 4A and 4B. The steps in these flowcharts are described in detail in FIGS. 5A-32C below to describe the exemplary embodiment of the invention.

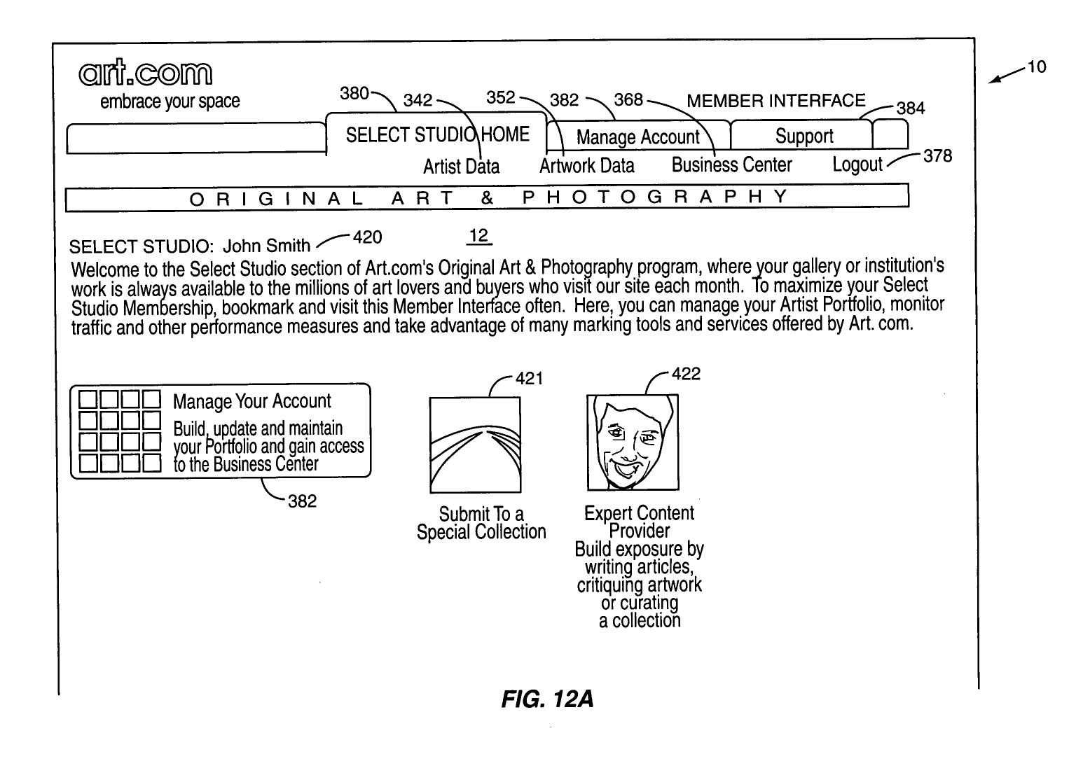

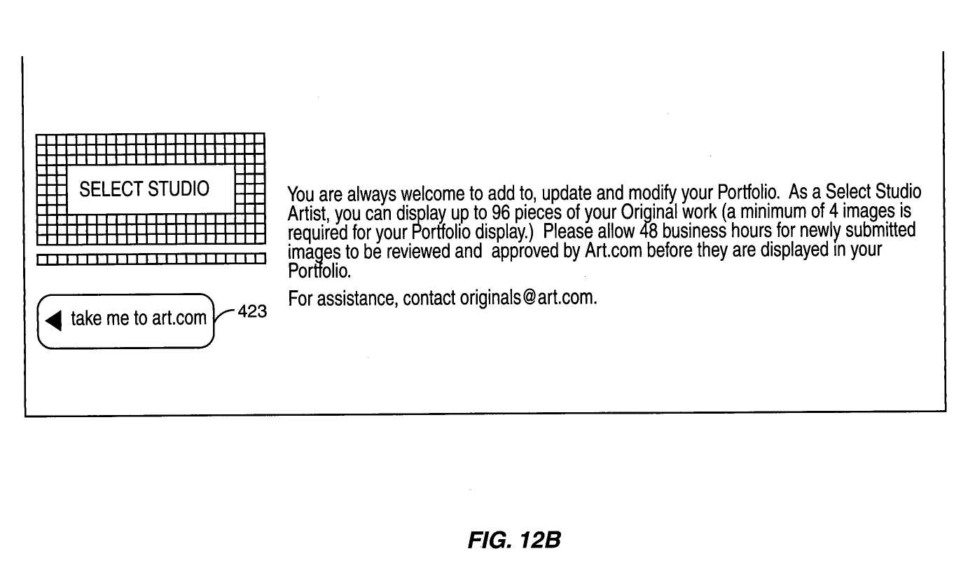

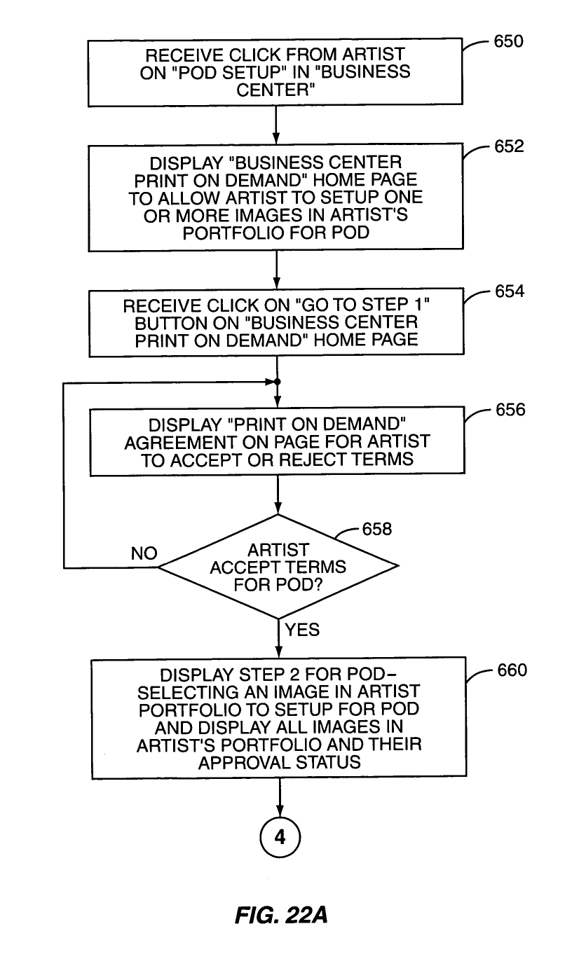

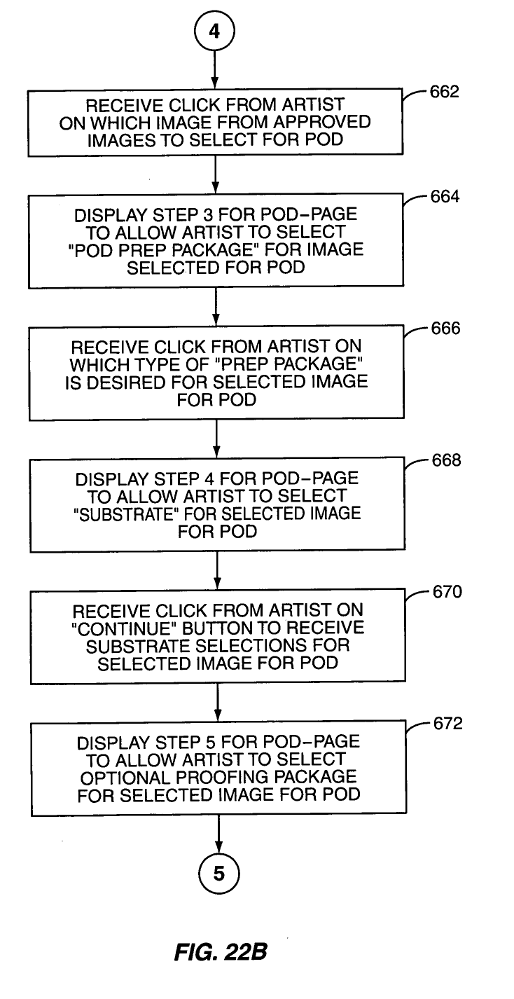

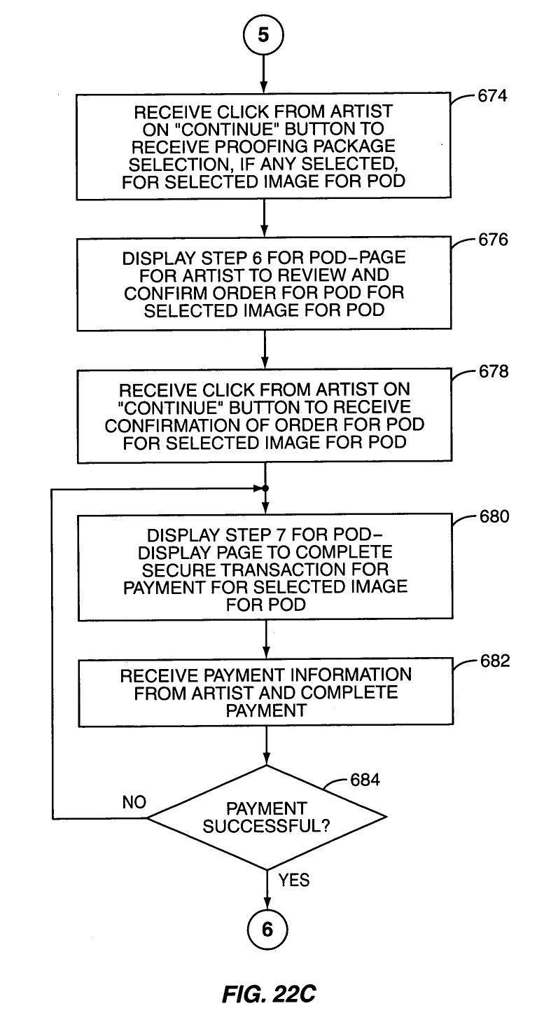

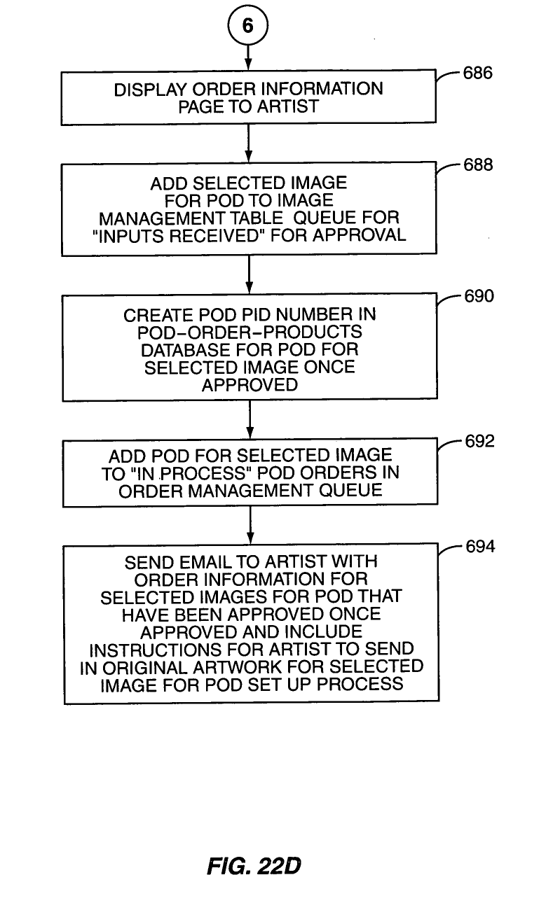

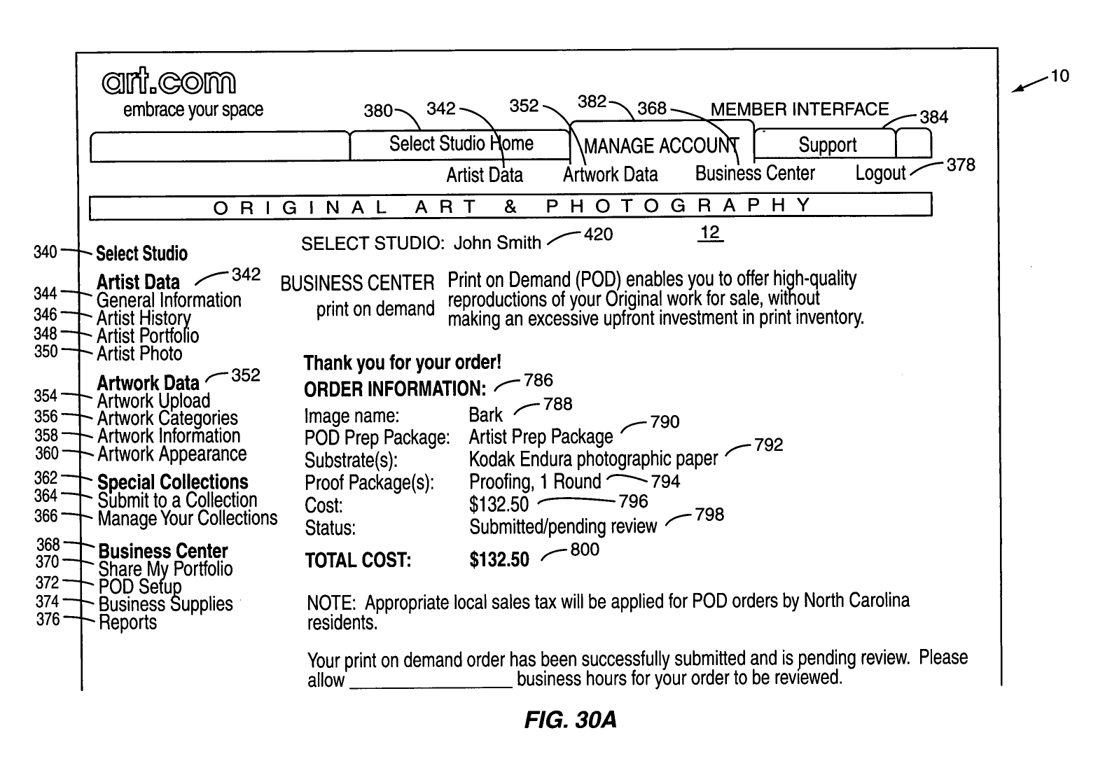

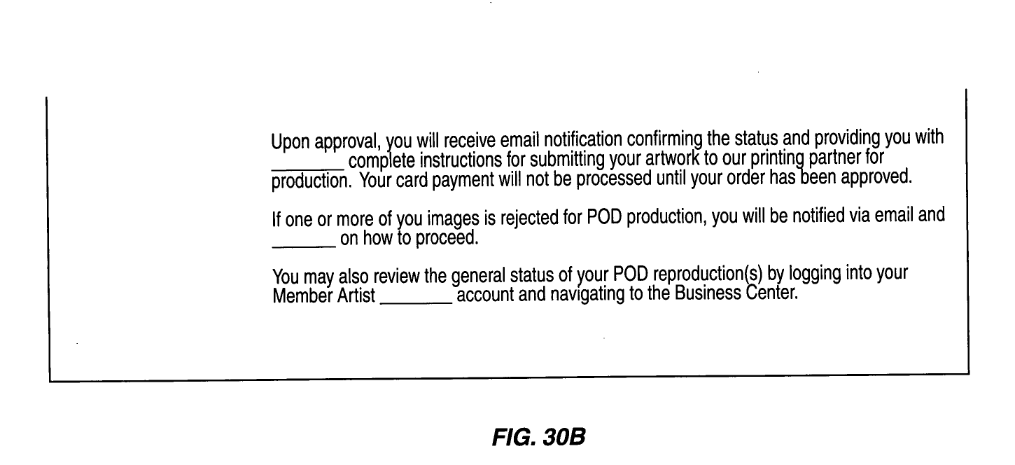

Turning to FIG. 4A, the process starts (step 200), and the Art.com website receives a request for an artist to log into OAP (step 202). This process is described below and is illustrated in FIGS. 5A-11. After the artist logs into OAP (step 202), the Art.com website receives a request from the artist to upload artwork to store in memory associated with the artist's portfolio (step 204). This process is described below and is illustrated in FIGS. 12-17. Approval is next received for the uploaded artwork before the artwork can be displayed to other users of the Art.com website or selected for POD (step 206). After approval is received (step 206), the Art.com system updates the status of the artwork as being approved for access by other users as well as available for POD (step 208). This process is described below and is illustrated in FIGS. 22-29. Thereafter, the artist can select artwork that has been approved (step 210) for POD and include payment information for billing, if required (step 212). Once the artwork selected for POD is approved, the artist is notified (step 214). This process is described below and is illustrated in FIGS. 30-32C. Next, the artist then submits the proofing materials for the artwork for the POD process to be completed (step 216—FIG. 4B), and the artwork is made available on the Art.com website for purchase as an original reproduction (step 218), and the process ends (step 220).

Establishment of OAP Artist Account

As described above for step 202 in FIG. 4A, the artist must login into OAP as a member in order to upload artwork to the Art.com system through the Art.com website. A user can access OAP on the Art.com website with or without registering as a member. As illustrated in FIG. 1A, the user can browse artwork of other artists that has been previously uploaded and approved by selecting the “Browse Original Art & Photography” link 34. The user can click on the “Featured Artists” link 36 to cause the Art.com website to grant the user access to featured artists within OAP. The user can select the “Exhibiting Partners” link 38 to access artwork of exhibiting partners who have previously registered exhibits on the Art.com website and been approved. The user can access artwork in special collections by clicking the “Special Collections” link 40.

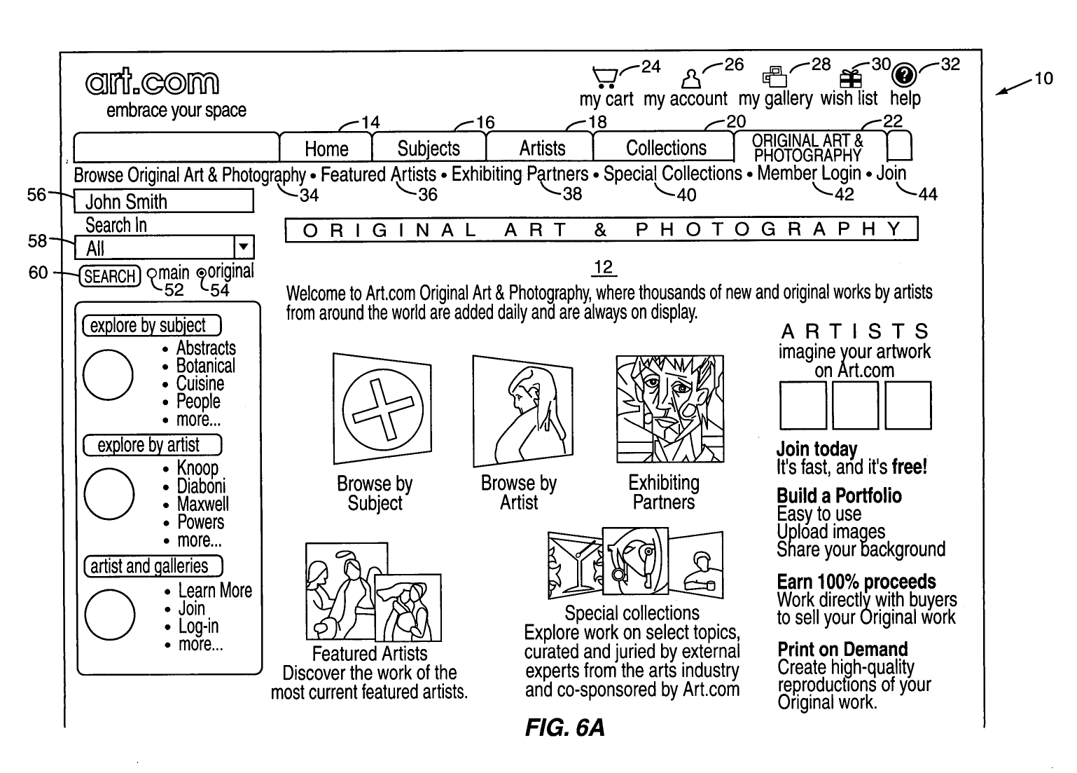

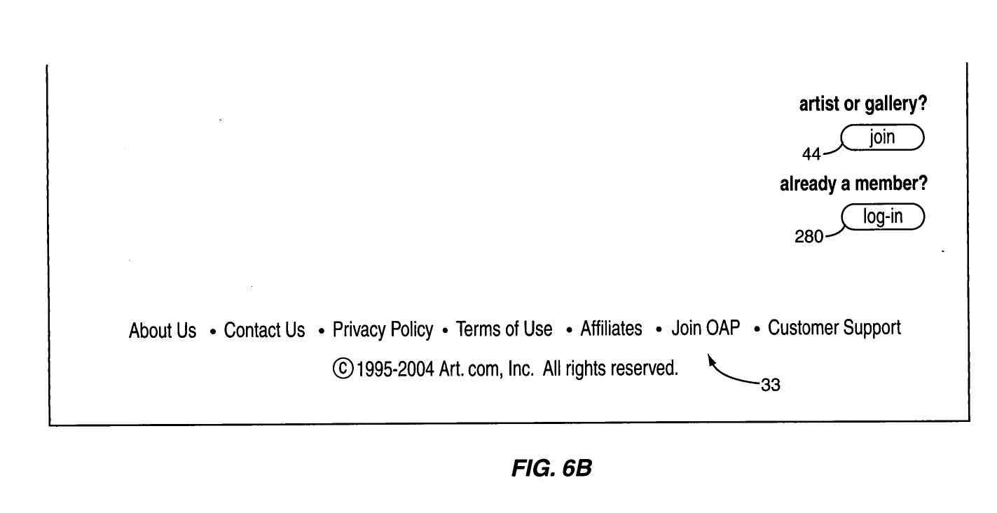

In order for a user to use OAP as a member artist to be able to upload artwork images to the Art.com website for storage in a portfolio and/or selection for POD, the artist must login to OAP. This process is illustrated in the flowcharts of FIGS. 5A and 5B and is illustrated on the pages in FIGS. 6-10. References to the flowcharts in FIGS. 5A and 5B will correspond to pages illustrated in FIGS. 6-10.

As illustrated in FIG. 5A, first, the artist must enter the OAP section of the Art.com website (step 250). The artist can accomplish this by selecting the “OAP” tab 22 as discussed above and illustrated in FIG. 6A. After the artist selects the “OAP” tab 22 to enter OAP, the Art.com website sends a page to the user's computer 74 to display the page illustrated in FIGS. 6A and 6B. At this point, the artist is not accessing the portion of the OAP on the Art.com website that requires the user to be a member. Again, as discussed above, the user can select links 34, 36, 38, 40 to access artwork in OAP, enter a search request or explore by categories. If the artist desires to login into OAP, the user must select the “Member Login” link 42 illustrated in FIG. 6A. If the artist is not an existing member of OAP, the artist must join OAP; in which an account will be created by the Art.com system in the OAP database 108, as previously described above. The artist can select the “Join” link 44 or the “Join OAP” link 33 (in FIG. 6B) to join OAP.

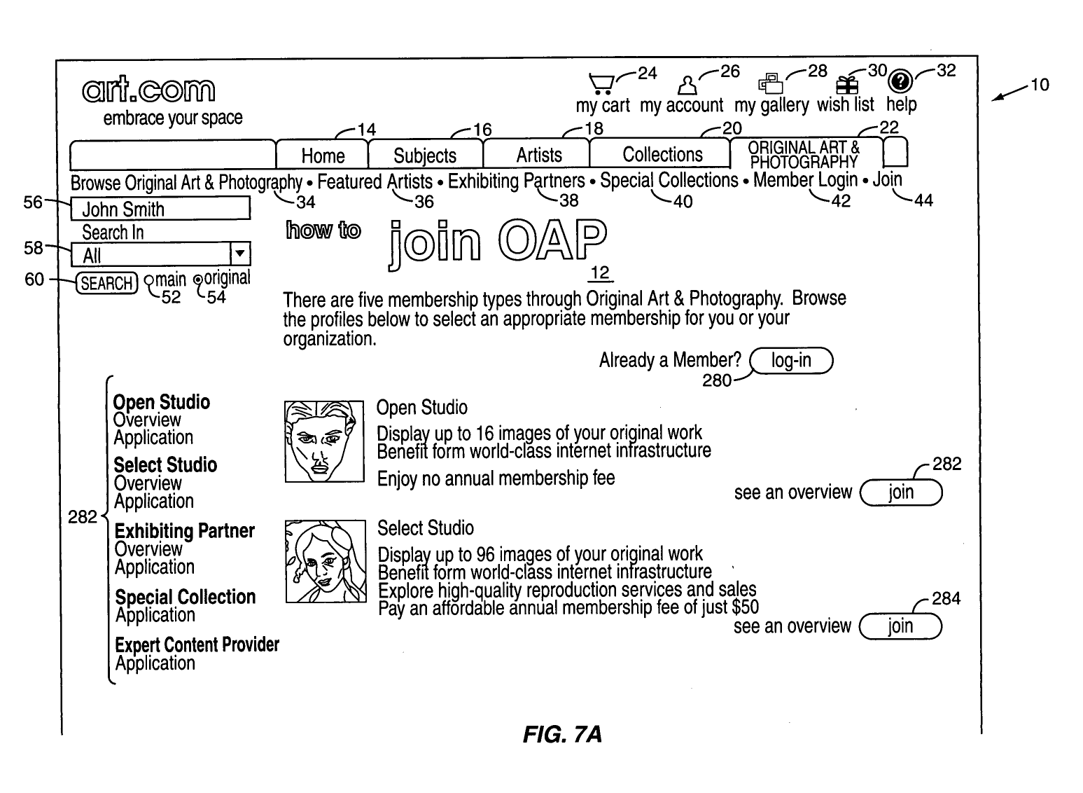

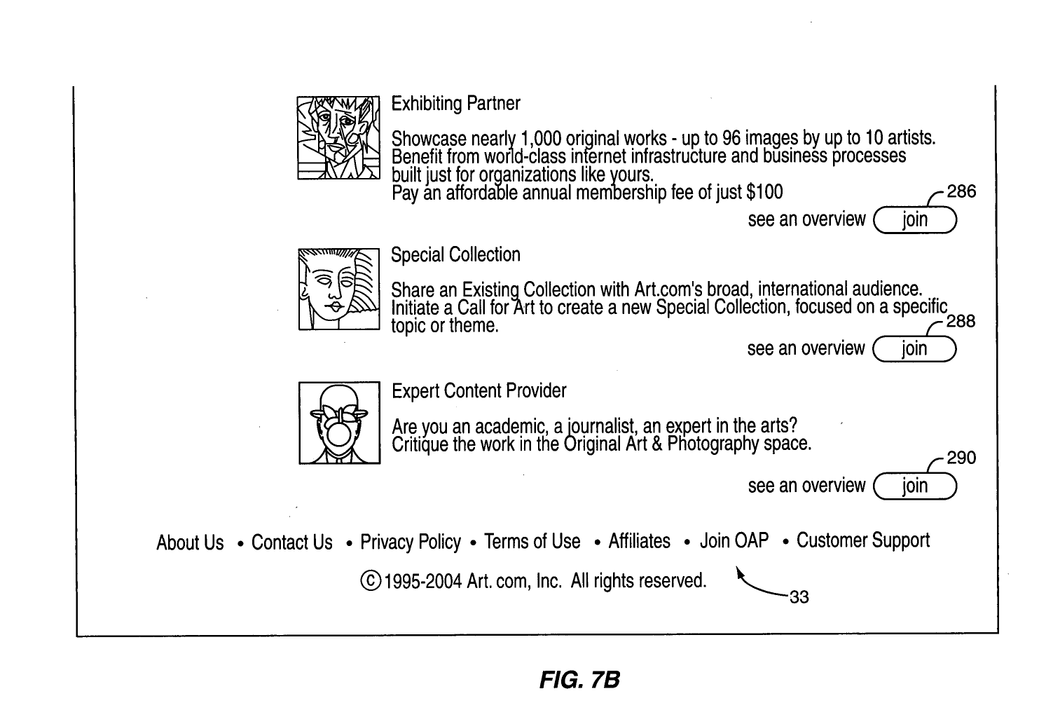

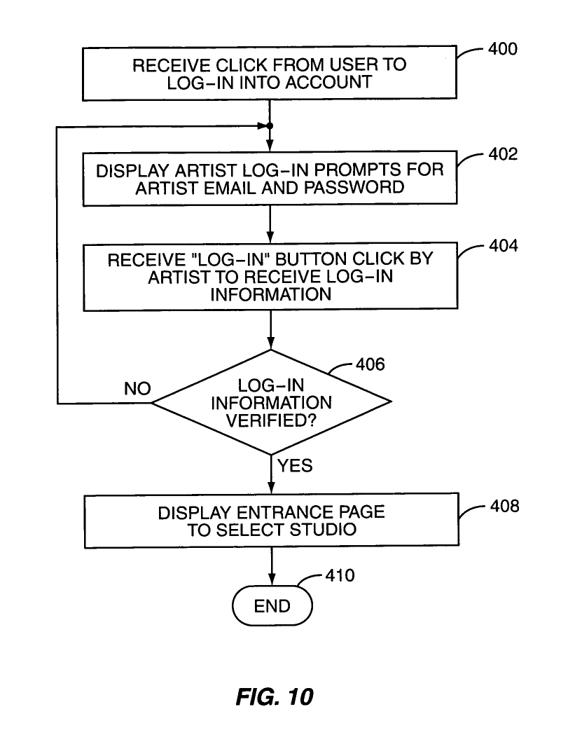

It is assumed for the purposes of this example that the artist is not yet a member of OAP, in which case the artist selects the “Join” link 44 as illustrated in step 252 in FIG. 5A. After the artist clicks the “Join” link 44, the Art.com website displays a page illustrated in FIGS. 7A and 7B, showing the artist the different types of OAP memberships that are available (step 254 in FIG. 5A). Turning to FIGS. 7A and 7B, a page is displayed that shows the different types of memberships in OAP. The membership types illustrated are “Open Studio,” “Select Studio,” “Exhibiting Partner,” “Special Collection,” and “Expert Content Provider.” The artist can request to join any of these membership types by selecting the corresponding “join” button 282, 284, 286, 288, 290. If the artist is already a member and has reached the page illustrated in FIG. 7A, the artist can select the “log-in” button 280 to go immediately to the login process (described below starting at FIG. 10).

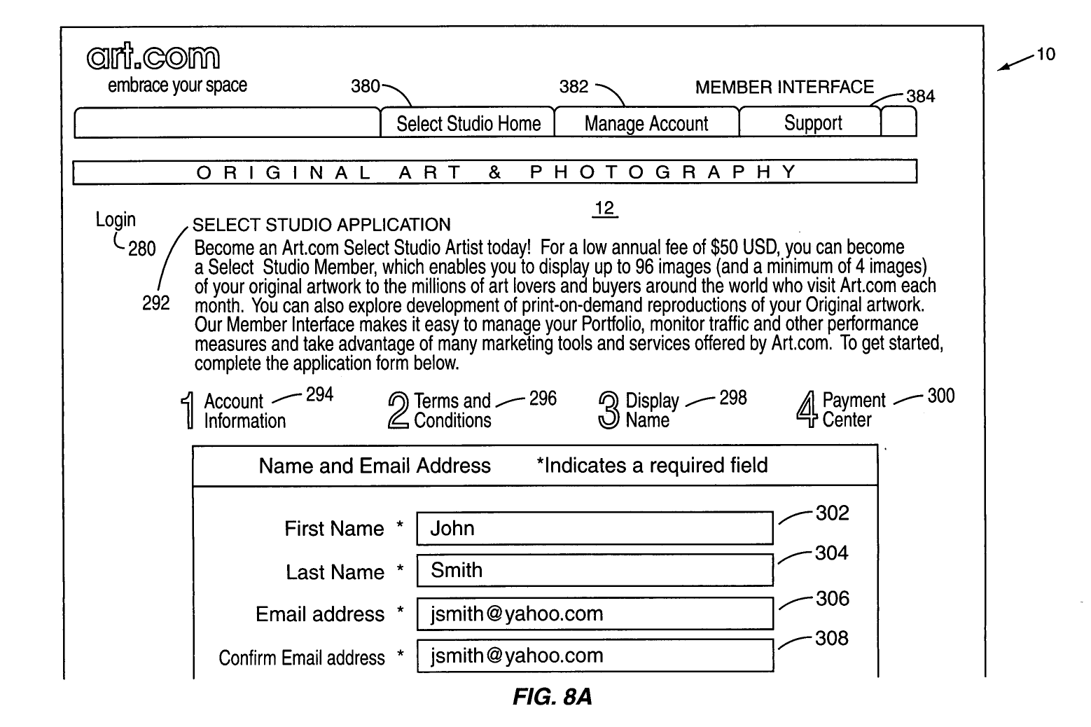

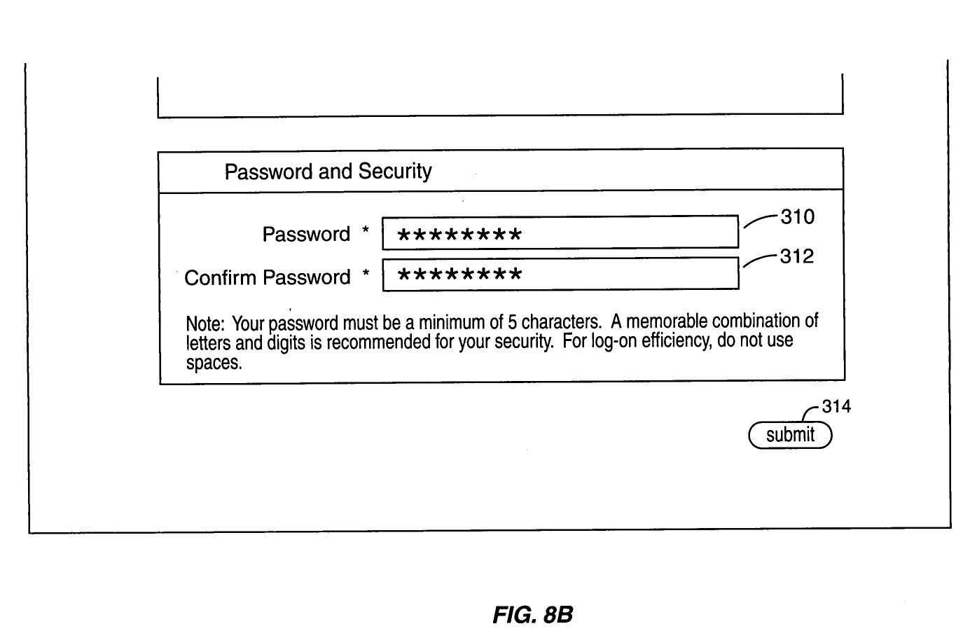

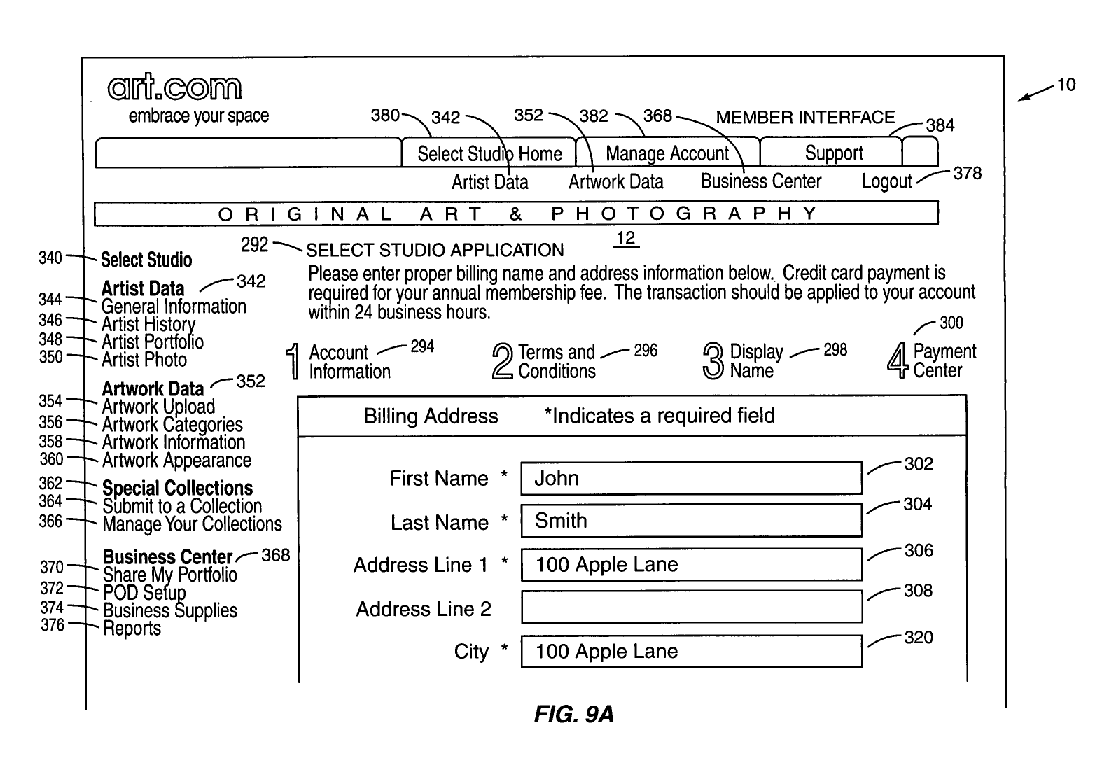

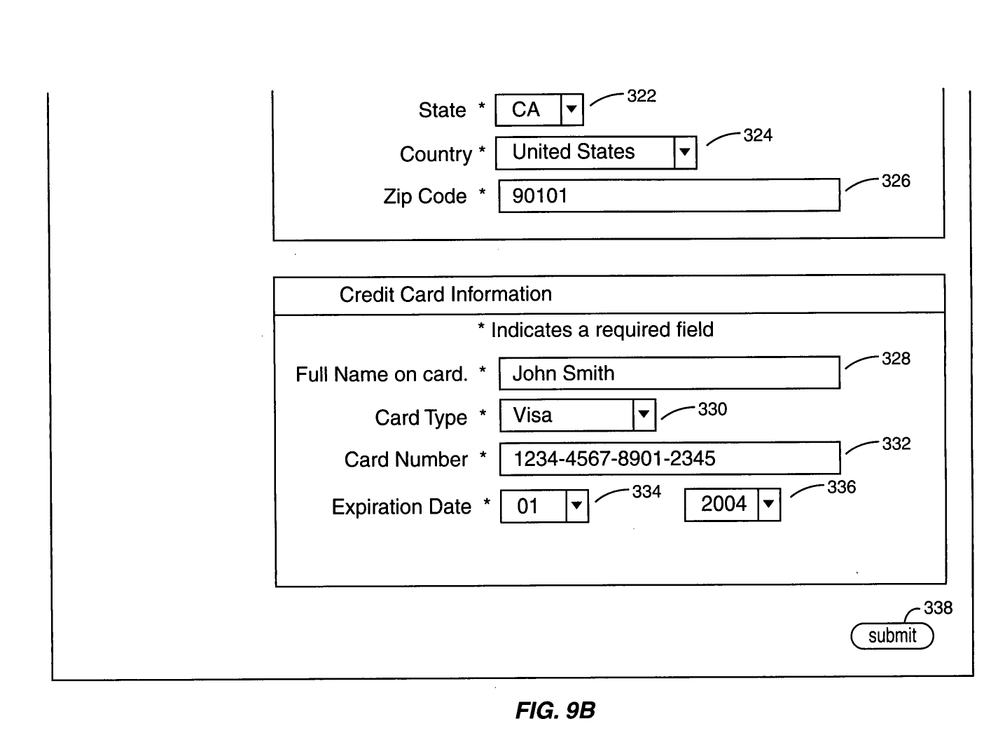

After an artist selects the OAP membership type by clicking one of the buttons 282, 284, 286, 288, 290 in FIG. 7A (step 256), the Art.com website receives the membership request and sends the membership information to be filled out by the artist as illustrated on the pages in FIGS. 8A and 8B, and FIGS. 9A and 9B. For the purposes of this exemplary embodiment, it is assumed that the artist selected the “Select Studio” OAP membership type.

As illustrated in FIG. 8A, the Art.com website causes a page to be displayed to obtain the necessary information from the artist to create a membership account for the artist. The page displays the type of application as the “Select Studio Application” 292 and information about this type of account. Links are displayed to allow the user to enter “Account Information” 294, agree to “Terms and Conditions” 296, enter information about artist's name and information called “Display Name” 298, and “Payment Center” 300 for payment to establish an OAP account, if payment is required. The Art.com website may be configured to either require or not require payment from the artist to establish an OAP account according to the discretion of the operator of the Art.com website. The artist can select the links 294, 296, 298, 300 to move back and forth to pages for each of these areas of information as the artist deems necessary, but each section must be completed in order to submit the application for membership to the Art.com website.

The page that is delivered by default is for the artist to enter his or her “Account Information” as displayed in FIGS. 8A and 8B. The artist must enter their first name in the “First Name” text box 302, and their last name in the “Last Name” text box 304. The artist must provide an email address in the “Email address” text box 306, and a confirmation of same in the “Confirm Email address” text box 308. Next, the artist must provide a password and confirmation of the password in the “Password” text box 310 and the “Confirm Password” text box 312, respectively. After this information is entered by the artist, the artist clicks on the “submit” button 314 to send this information to the Art.com website (step 258 in FIG. 5A).

After the “submit” button 314 is clicked, the Art.com website checks the information entered by the Artist for syntax and to ensure that the artist's email and passwords and their confirmations are consistent. If so, the Art.com website then sends a page to the artist's computer 72 with the terms and conditions to which the artist must agree before the account is established for the artist in OAP (step 260 in FIG. 5A). If the artist does not accept the terms and conditions of OAP necessary to establish an account (decision 262), the Art.com website will not continue to allow the artist to proceed with the membership application. If the artist does accept the terms and conditions (decision 262), the Art.com website will receive such acceptance and will in turn send a page to the artist's computer 74 to display the “Display Name” information prompts to the artist (step 264 in FIG. 5A) in order for the artist to provide the necessary information to establish a URL specific to the artist on the Art.com website (step 266 in FIG. 5B). The Art.com website establishes a URL specific to a page in the Art.com website dedicated to the artist in the form of http://www.art.com/<Artist's Name> so that users can access a page specific to an artist to view the artist's artwork when uploaded and approved, as will be discussed below in this application.

Next, if the Art.com website is configured to require payment from the artist to establish the OAP account, the Art.com website sends a page to the artist's computer 74 to display the “Payment Center” prompts for the artist to enter payment information as illustrated in FIGS. 9A and 9B (step 268 in FIG. 5B). A page is shown that is displayed to the artist to enter the artist's name and address and payment information if payment is required to join OAP. Again, the artist enters their first and last name in the “First Name” text box 302 and the “Last Name” text box 304, respectively. Next, the artist enters their address in the “Address Line 1,” “Address Line 2,” and “City” text boxes 306, 308, 320. The state of the address is selected by the artist from the “State” drop down menu 322. The country and zip code are also entered by the artist on the “Country” drop down menu 324 and in the “Zip Code” text box 326.

Next, the artist provides “Credit Card Information” for payment for their OAP membership. The artist provides their name in the “Full Name” text box 328. The artist next provides their credit card type in the “Card Type” drop down menu 330, and their card number in the “Card Number” text box 332. Lastly, the artist provides the month and year of their credit card expiration in the “Expiration Date” month drop down menu 334, and the “Expiration Date” year drop down menu 336. After all payment information is entered, the artist clicks the “submit” button 338 to proceed with the OAP application in which the information entered is sent by the artist's computer 74 to the Art.com website, where it is received for payment authorization (step 270 in FIG. 5B).

If payment is authorized, the Art.com website establishes the artist's account by creating an entry in the “Members” table 110 in the OAP database 108 (illustrated previously in FIG. 3) with a the artist's email as the “Member ID” and the password entered as the “Password” (step 272 in FIG. 5B), and the process ends (step 274 in FIG. 5B). In this manner, and as described below, the next time the artist logs into OAP portion of the Art.com website, the artist does not have to apply to establish an OAP account. The artist can select the “login” button 280 that allows the artist to sign in, and the Art.com website can verify the artist's login information by accessing the “Members” table 110 in the OAP database 108. Again, note that requirement of payment by the artist to establish an account is an optional step.

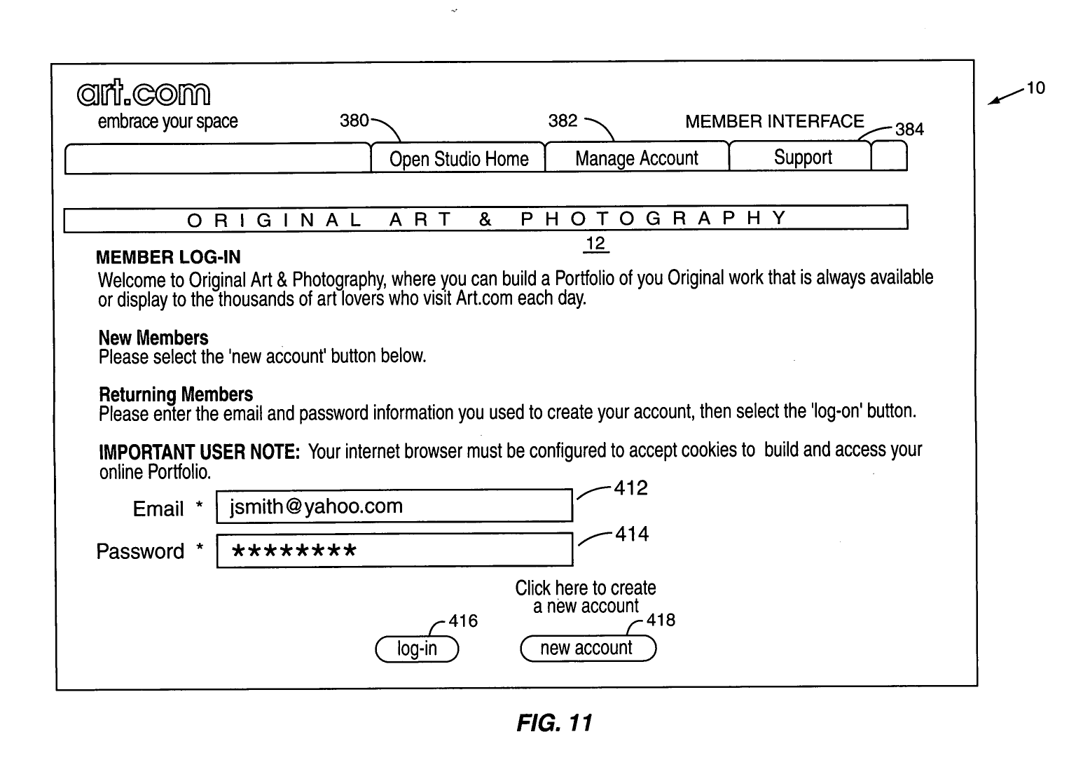

At this point, the artist has established an OAP account. If the artist has already gone through the aforementioned process to establish an OAP account, and the artist has established a new session with the Art.com website, the artist can thereafter choose to login into OAP with their existing account rather than join. The flowchart illustrated in FIG. 10 illustrates the process by which an artist who has an already established OAP account logs in rather than establishing a new account. The pages created by the Art.com website as a result of performing the steps in the process illustrated in FIG. 10 are illustrated in FIGS. 11-12.

As illustrated in FIG. 10, the process starts by the Art.com website receiving a request from an artist to log into their OAP account (step 400). The artist may have selected the “log-in” button 280 on the page illustrated in FIG. 6B or on the page illustrated in FIG. 7, for example. After the Art.com website receives the login request, the Art.com website sends a page to the artist's computer 74 to allow the artist to enter their account information (step 402). This page is illustrated in FIG. 11. The artist enters their email address in the “Email” text box 412, and their password in the “Password” text box 414. Thereafter, the artist either selects the “log-in” button 416 to send the account information to the Art.com website for verification. If the artist has reached the page illustrated in FIG. 11 without having already established an OAP account, the artist can select the “new account” button 418 instead, which will cause the process illustrated in the flowchart in FIGS. 5A and 5B to be executed as previously described.

After the artist clicks the “log-in” button 416, their computer 74 sends the account information (i.e. email and password) to the Art.com website where it is received (step 404 in FIG. 10). The Art.com website verifies the account information by performing a look-up in the “Members” table 110 in the OAP database 108. If the member's ID (email) is found, the password stored in the entry for the member's ID in the “Members” table 110 is compared with the password received from the artist (step 404) to verify (decision 406). If not correct, the Art.com website does not allow the artist to log-in with the account information provided, and the Art.com website sends a page to the artist to allow the artist to re-enter their account information. If the account information is correct and verified, the Art.com website sends a page to the artist's computer 74 to display the entrance home page to “Select Studio” in OAP (step 408), and the process ends (410). At this point, the artist is now logged into their OAP account and can proceed with uploading artwork and selecting artwork for POD, as described in the remainder of this application.

The home page for “Select Studio” in the OAP section of the Art.com website is illustrated in FIGS. 12A and 12B. The artist's name is displayed in the artist name field 420 along with welcome text. Additionally, the “Select Studio Home” tab 380 is shown as selected, and the artist can select the “Manage Account” tab 382 to manage their account, or the “Support” tab 384 to request a page with support from the Art.com website.

The artist can choose to manage their account, submit their artwork to a special collection that has been established by selecting the “Submit To a Special Collection” link 421, or access the “Expert Content Provider” portion of OAP by selecting link 422. The artist can also choose to provide biographical information about himself or herself by selecting the “Artist Data” link 342, provide information about uploaded artwork by selecting the “Artwork Data” link 352, a business center to access POD, as will be described later, by selecting the “Business Center” link 368, or logging out of OAP by selecting the “Logout” link 378. The artist can also choose to leave OAP without logging out and returning to the main portion of the Art.com website by selecting the “take me to art.com” link 423 illustrated in FIG. 12B.

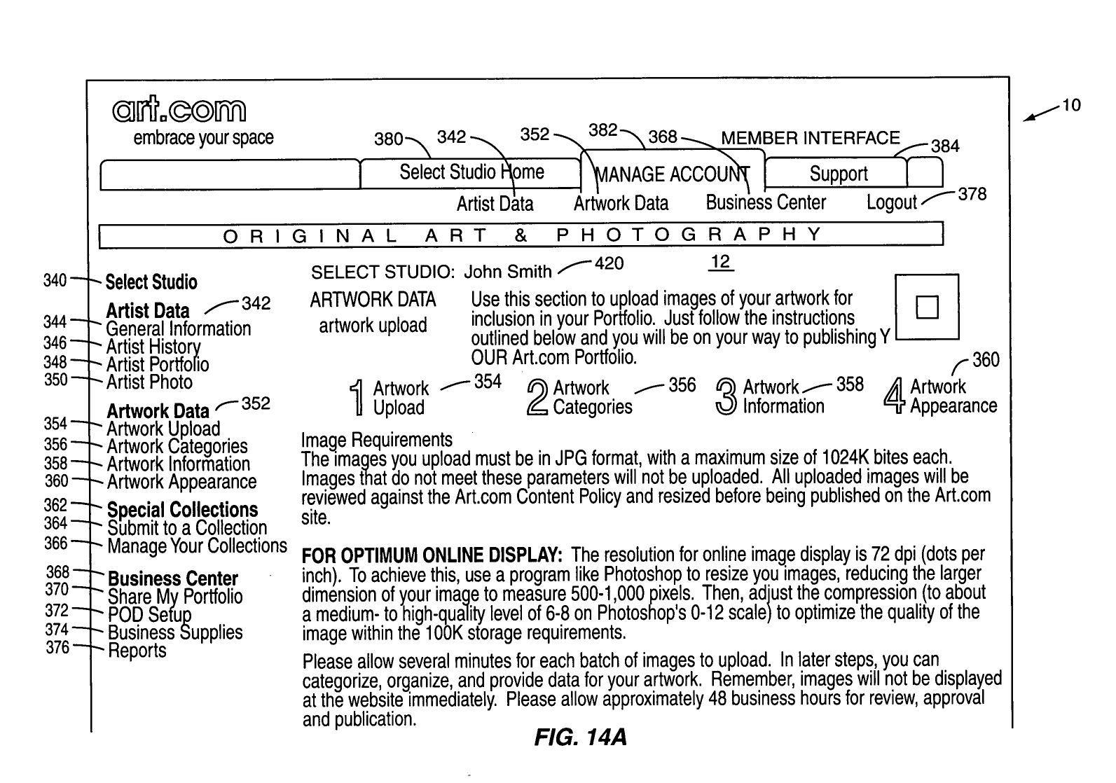

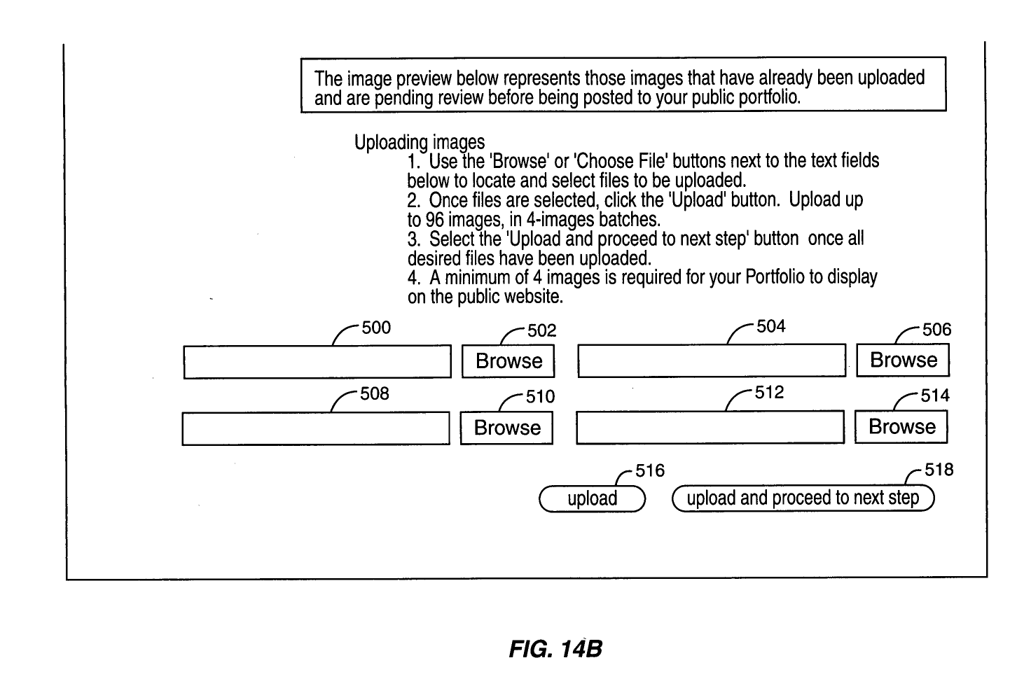

There are also other links on the left hand side of the page illustrated in FIGS. 9A and 9B that are available for the artist to jump to different places within OAP once the artist is logged in to OAP. The “General Information” link 344, the “Artist History” link 346, the “Artist Portfolio” link 348 and the “Artist Photo” 350 link allows the artist to provide general information about themselves, their history, their portfolio, and their photo, to be stored in the Art.com website and displayed to other users. The “Artwork Upload” link 354, the “Artwork Categories” link 356, the “Artwork Information” link 358, and the “Artwork Appearance” link 360 access pages in the “Artwork Data” 352 section of OAP that are described below and illustrated in FIGS. 14A-21. In the “Special Collections” section 362, the “Submit to a Collection” link 364, and the “Manage Your Collections” link 366 allow the artist to access the special collections pages in OAP if the artist desires to set up a special collection of artwork, desires to submit their artwork to an established special collection, or desires to manage collections established under their name. The “Business Center” link 368, and its sublinks “Share My Portfolio” link 370, “POD Setup” link 372, “Business Suppliers” link 374 and “Reports” link 376 allow the artist to access the Business Center section of OAP, as will be described in more detail below I and illustrated in FIGS. 22-30B.

The next functionality that will be described with respect to OAP is the ability of an artist to upload images of their original artwork to the Art.com website to place in their portfolio and to be able to select for sale to other users on the Art.com website as originals or reproductions using POD. The uploading process is described below.

Uploading Artwork

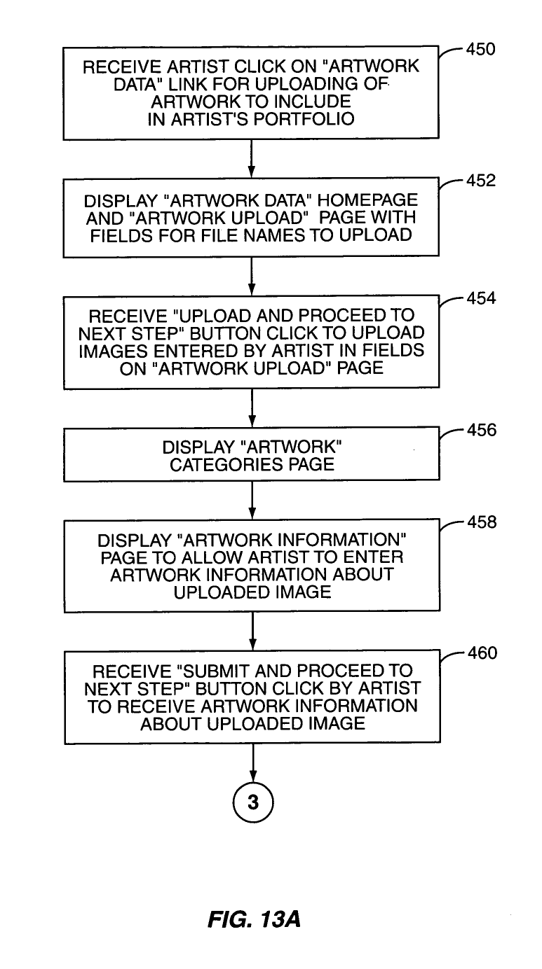

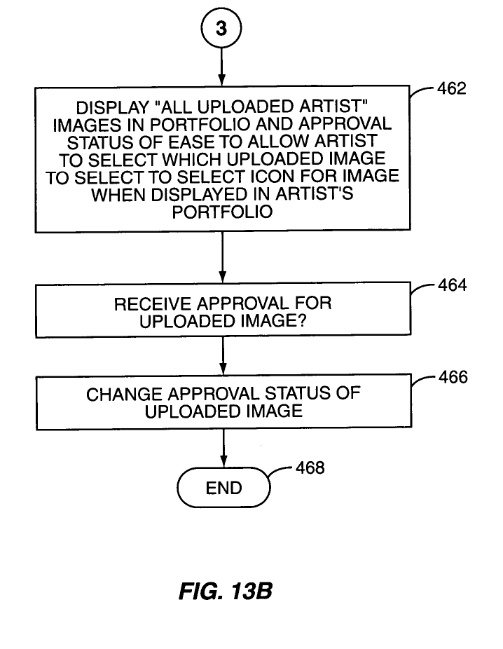

Now that the artist has successfully logged into their account in OAP, the artist is allowed to upload artwork to the Art.com website to store in their portfolio. The process for uploading artwork for this exemplary embodiment is illustrated in the flowchart in FIGS. 13A and 13B. Pages that are created by the Art.com website and are sent to the artist's computer 74 for display as a result of the steps in the flowcharts illustrated in FIGS. 13A and 13B are illustrated in FIGS. 14A-18B.

Turning to the flowchart in FIG. 13A, in order for an artist to upload artwork to their portfolio on the Art.com website, the artist must select “Artwork Data” link 352 (illustrated in FIG. 12A). Once the artist selects the “Artwork Data” link 352, the Art.com website receives the selection (step 450) and generates a web page to send to the artist's computer 74 to display the “Artwork Data” home page and “Artwork Upload” page with fields to enter path names of images files for artwork as illustrated on the page in FIGS. 14A and 14B to upload (step 452).

As illustrated in FIGS. 14A and 14B, after the artist has selected the “Artwork Data” link 352, the “Artwork Data” uploading process is displayed. The process of uploading artwork consists of uploading the artwork, selecting the categories for the artwork uploaded, providing information about the artwork, and selecting the icon that appears for the artwork as it will be displayed on the Art.com website. These steps are also shown as links in FIG. 14A as the “Artwork Upload” link 354, “Artwork Categories” link 356, “Artwork Information” link 358, and the “Artwork Appearance” link 360. The artist can click these links out of order if desired to complete the process for uploading artwork, but if the artist clicks on the links provided to proceed to the next steps, each step will be generated by the Art.com website in order.

As illustrated in FIG. 14B, the artist can provide the path and image file name for artwork to be uploaded in the file name text boxes 500, 504, 508, 512. Up to four image files may be uploaded at one time. “Browse” buttons 502, 506, 510, 514 are provided if the artist needs to browse the directory structures on the computer 74 to locate the image files desired for uploading. After the image file names are provided by the artist in the image file name text boxes 500, 504, 508, 512 as desired, the artist can choose to request the upload by selecting the “upload” button 516 or to upload and proceed to the next step (“Artwork Categories”) by selecting the “upload and proceed to next step” button 518 as illustrated in FIG. 14B.

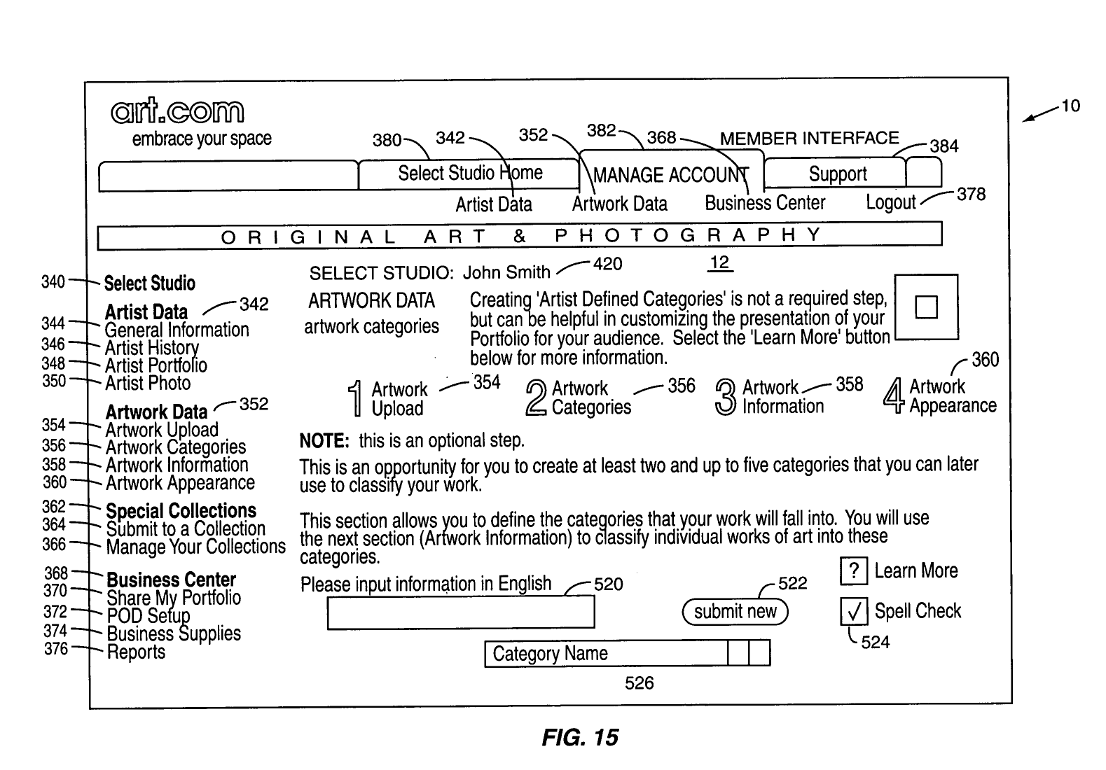

After the artist selects the “upload and proceed to next step” button 518, the images are sent by the artist's computer 74 to the Art.com website and received by the Art.com website (step 454 in FIG. 13A). Thereafter, the Art.com website creates a page to send to the artist's computer 74 to display the “Artwork Categories” page as illustrated in FIG. 15 as an optional step (step 456 in FIG. 13A). As illustrated in FIG. 15, the artist can define categories by providing the category name in the category name text box 520, and clicking the “submit new” button 522 to send the category name to the Art.com website. The artist can click on the “Spell Check” link 524 to spell check the category name if desired. All category names previously established by the artist for his or her account are displayed in the “Category Name” listing 526.

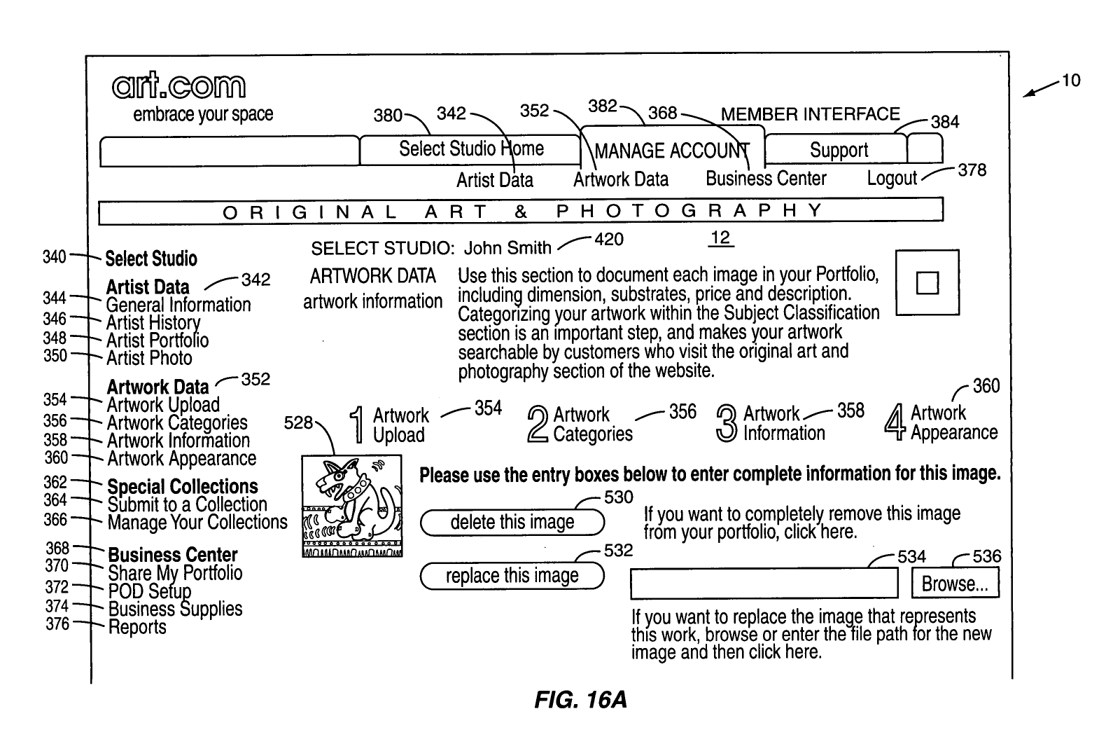

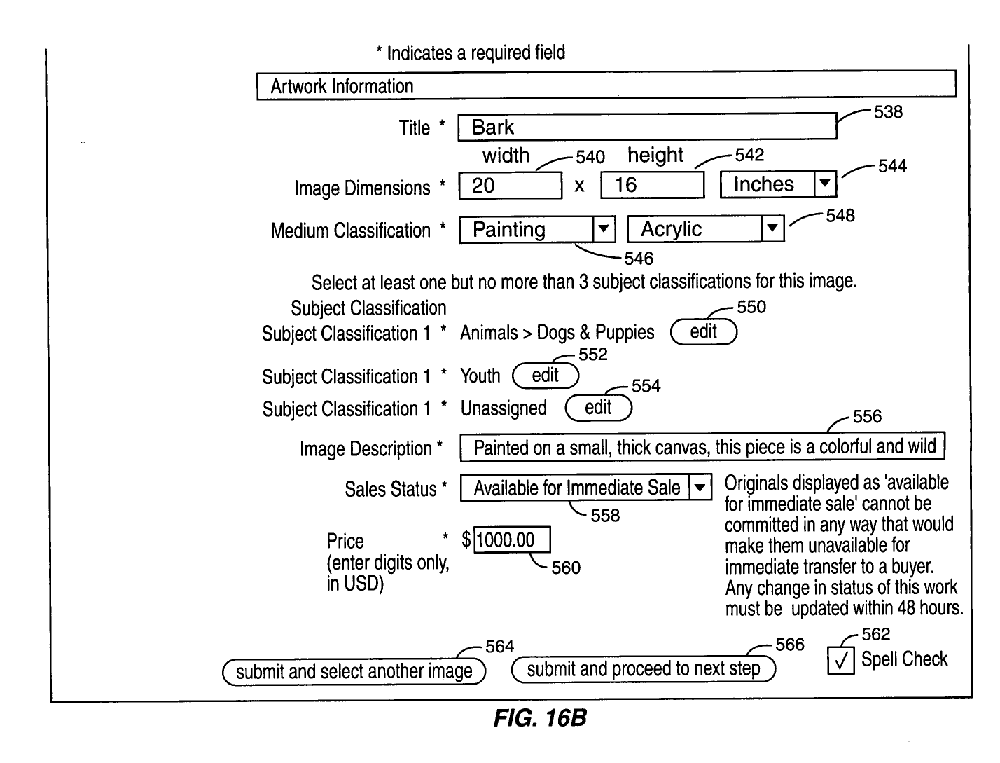

The next step in the uploading artwork process is to provide information about the artwork in the “Artwork Information” page that is created and sent by the Art.com website to the artist's computer 74 (step 458 in FIG. 13A) as illustrated in FIGS. 16A and 16B. The “Artwork Information” page allows the artist to provide more descriptive detail of the exact nature of the artwork, including the image icon 528 to be shown on the Art.com website as representative of the artwork. The Art.com website automatically selects an icon image 528 based on the uploaded image file for the artwork. The artist can delete the icon image 528 by selecting the “delete this image” button 530, and choose to replace the image file with another icon image by entering the file name of another image file in the icon image file text box 534. The artist can select the “Browse” button 536 to browse the directory structure of their computer 74. Once an icon image is selected by the artist by entering its file name in the icon image file name text box 534, the artist selects the “replace this image” button 532 to replace the icon image, in which case the Art.com website will send a refreshed page of FIGS. 16A and 16B with a replacement icon image 528 selected by the artist. If the icon image 528 selected automatically by the Art.com website is acceptable to the artist, the artist can skip the aforementioned steps to replace the icon image 528.

The artist can enter the title of the artwork by entering a title name in the “Title” text box 538 in FIG. 16B. The artist can enter the dimensions of the artwork by entering the width and height dimensions and the units of measurement in the width text box 540, the height text box 542, and selecting the unit of measurement from the drop down menu 544. Next, the artist can select the classification of the artwork by selecting an option from the “Medium Classification” drop down menus 546, 548. Next, the artist can edit the “Subject Classifications” selected by the Art.com website by selecting the “edit” buttons 550, 552, 554. If the artist desires to enter an image description, the artist can enter such in an “Image Description” text box 556. If the artwork is to be listed as for sale, the artist can select the sales status by making a selection from the “Sales Status” drop down menu 558. The default is that the artwork is for immediate sale. The price of the artwork is entered in the “Price” text box 560. The artist can choose to spell check the text entered for the artwork by selecting the “Spell Check” link 562. This information about the uploaded artwork allows the artwork to be found using search criteria entered by a user using the Art.com website.

After the artist enters all of the information desired about the artwork uploaded, the artist can enter information about another uploaded image by selecting the “submit and select another image” button 564. This option is usually selected if more than one image file was uploaded in step 454 in FIG. 13A If the artist wants to proceed with completion of the uploading process, the artist selects the “submit and proceed to next step” link 566 in which case a message is sent to the Art.com website to receive the artwork information and to store such information associated with the artwork (step 460 in FIG. 13A).

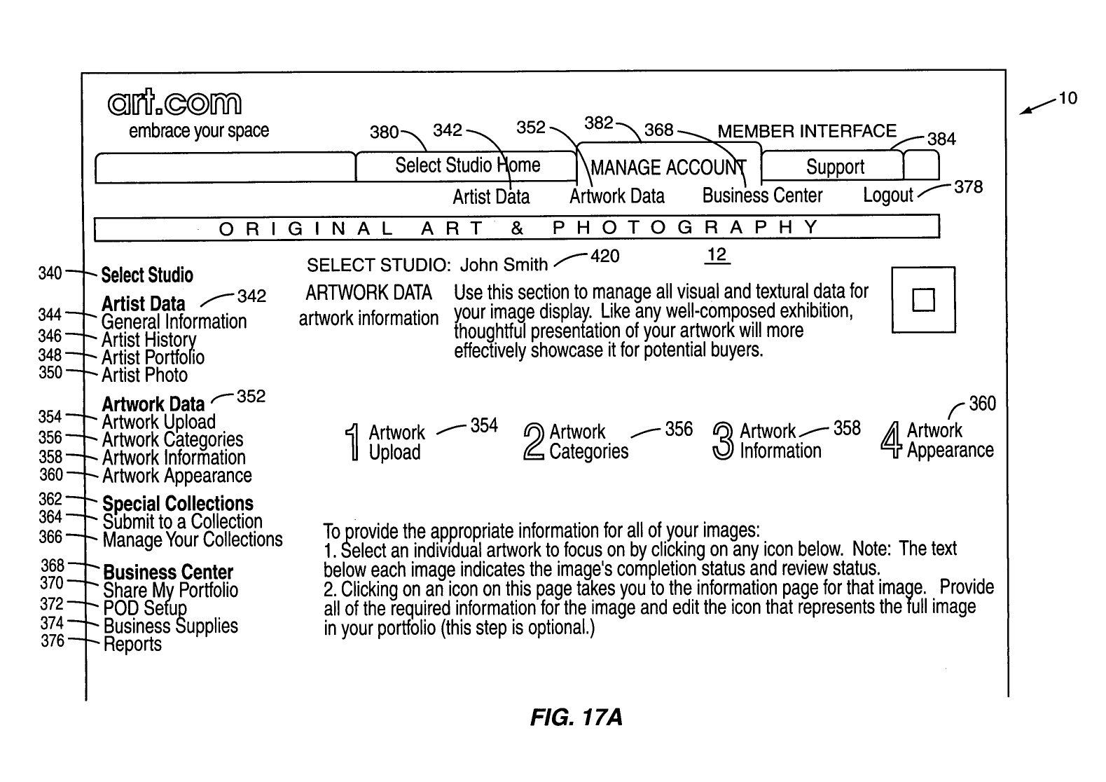

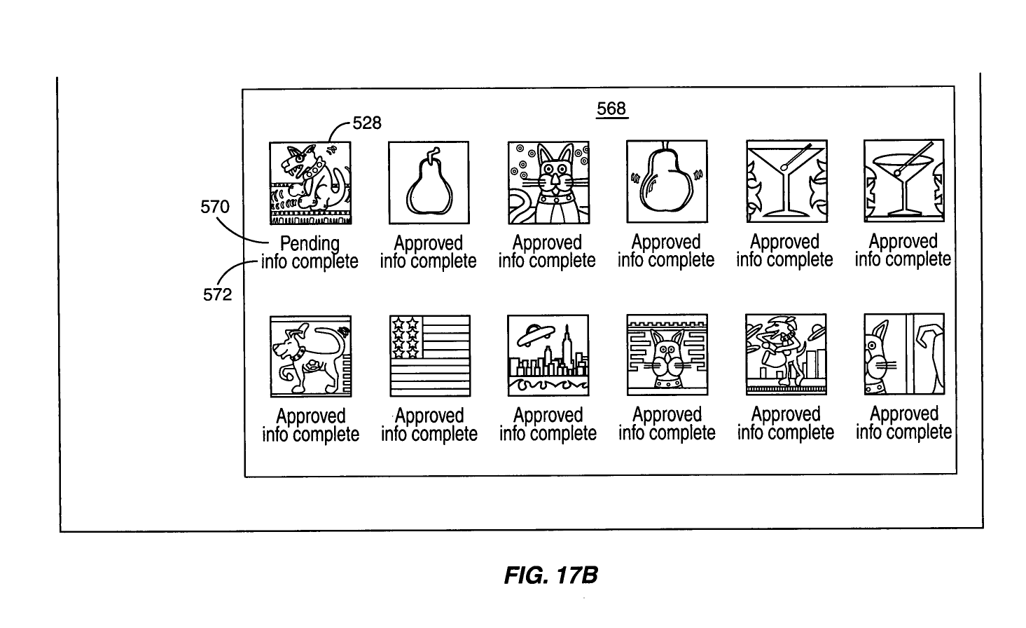

Once the artwork information is received by the Art.com website, the Art.com website creates a page to send to the artist's computer 74 to display the icon images 528 of all of the artwork uploaded into the artist's portfolio with the status of each artwork listed below each as illustrated in FIGS. 17A and 17B (step 462 in FIG. 13B). At this point, the images have been successfully uploaded into the artist's portfolio, but the artwork is not authorized to be accessed by other users of the Art.com website until the artwork is approved. As illustrated in FIGS. 17A and 17B, the icon images 528 of the artwork are displayed in the image display area 568. The image uploaded as an example in the previous pages is shown in entry 528 with a status field 570 of “Pending.” Below the status field 570 is a information entry 572 indicating whether information about the artwork from the “Artwork Information” step described above was completed, since it is possible for the artist to skip that step. Once the artwork is approved, the status field 570 for the image icon is changed from “Pending” to “Approved.” In the exemplary embodiment, images must be approved before they are accessible by other users of the Art.com website or selected for POD (described later in this application) so that content can be managed to only allow appropriate images to be uploaded. The approval is typically performed by an operator or administrator of the Art.com website.

Once the Art.com website receives approval of an uploaded image (step 464 in FIG. 13B), the Art.com website changes the status field 570 for the uploaded image to “Approved” (step 466 in FIG. 13B) and the uploading process ends.

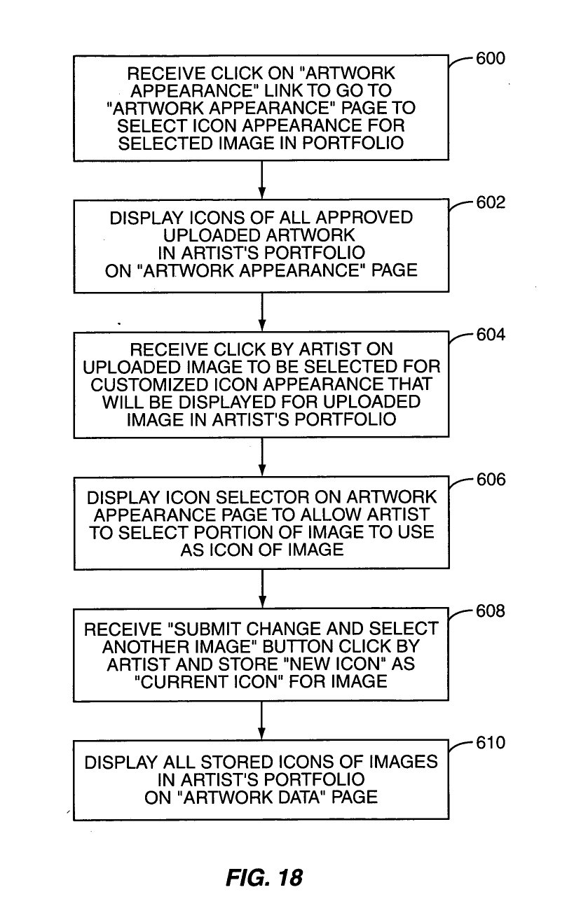

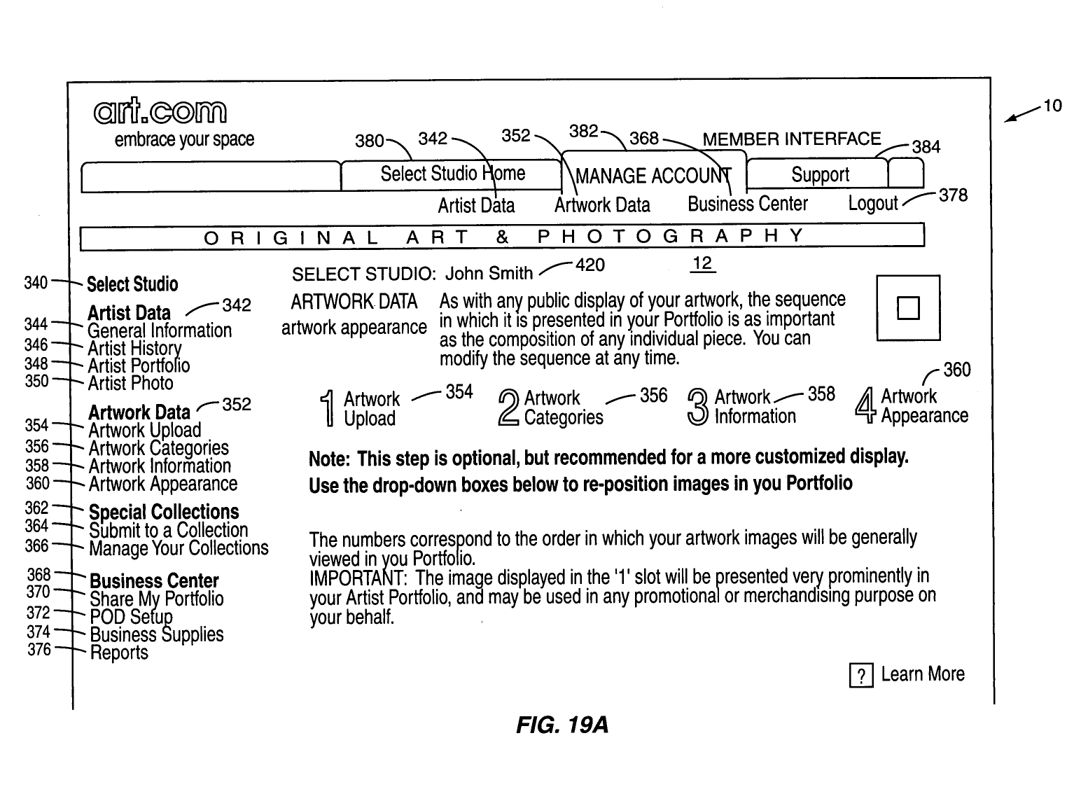

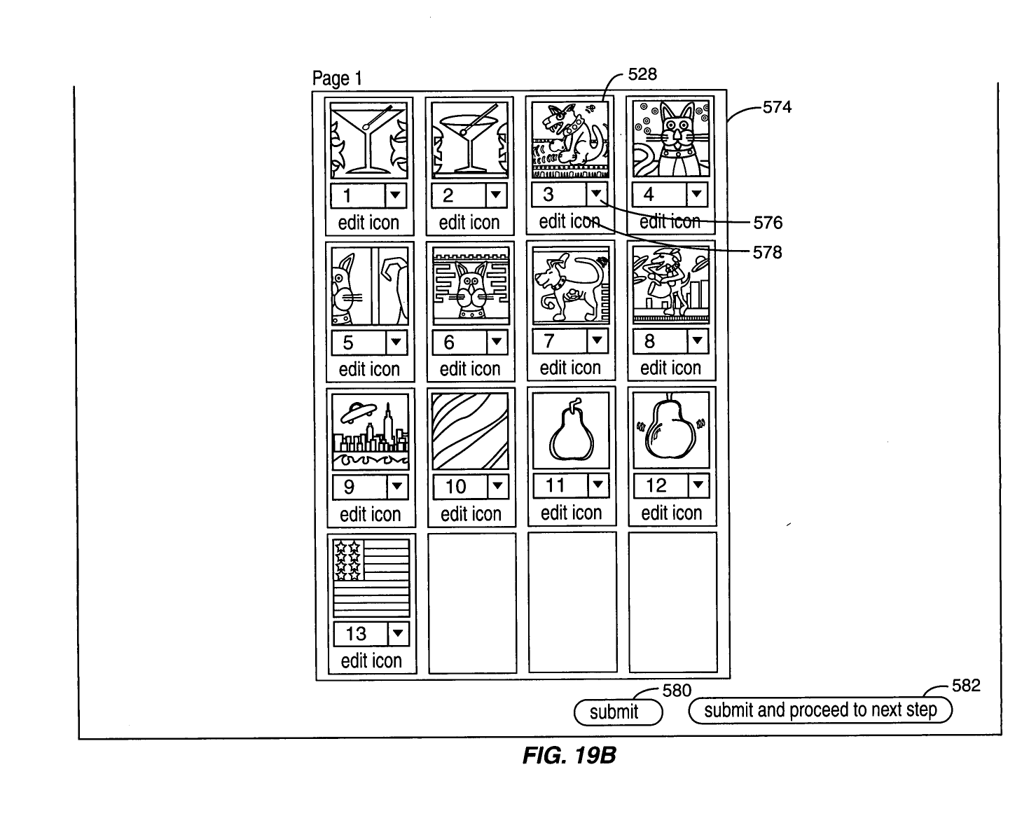

The artist, as an option, can choose to change the appearance of the icon image that represents the artwork that has been approved by selecting the “Artwork Appearance” link 360, but only after the image has been approved. If the artist selects this link, the process illustrated in the flowchart of FIG. 18 is performed by the Art.com website, and the pages illustrated in FIGS. 19A-21 are created by the Art.com website as a result.

If the user selects the “Artwork Appearance” link 360, the Art.com website receives a request to display the “Artwork Appearance” page as illustrated in FIGS. 19A and 19B (step 600 in FIG. 18). This selection allows an artist to customize the icon images 528 of the artwork that will be displayed to other users on the Art.com website accessing the artist's artwork. All approved icon images for artwork uploaded are displayed as illustrated in FIG. 19B (step 602 in FIG. 18). First, the artist can choose to change the order of appearance of their artwork icon images 528 when accessed by a user by selecting the number drop down menu 576. This may be important if a particular piece of artwork is more popular or desired to be displayed ahead of others. Further, if the artist desires to alter the icon image of their uploaded artwork, the artist can click on the “edit icon” link 578 as described below.

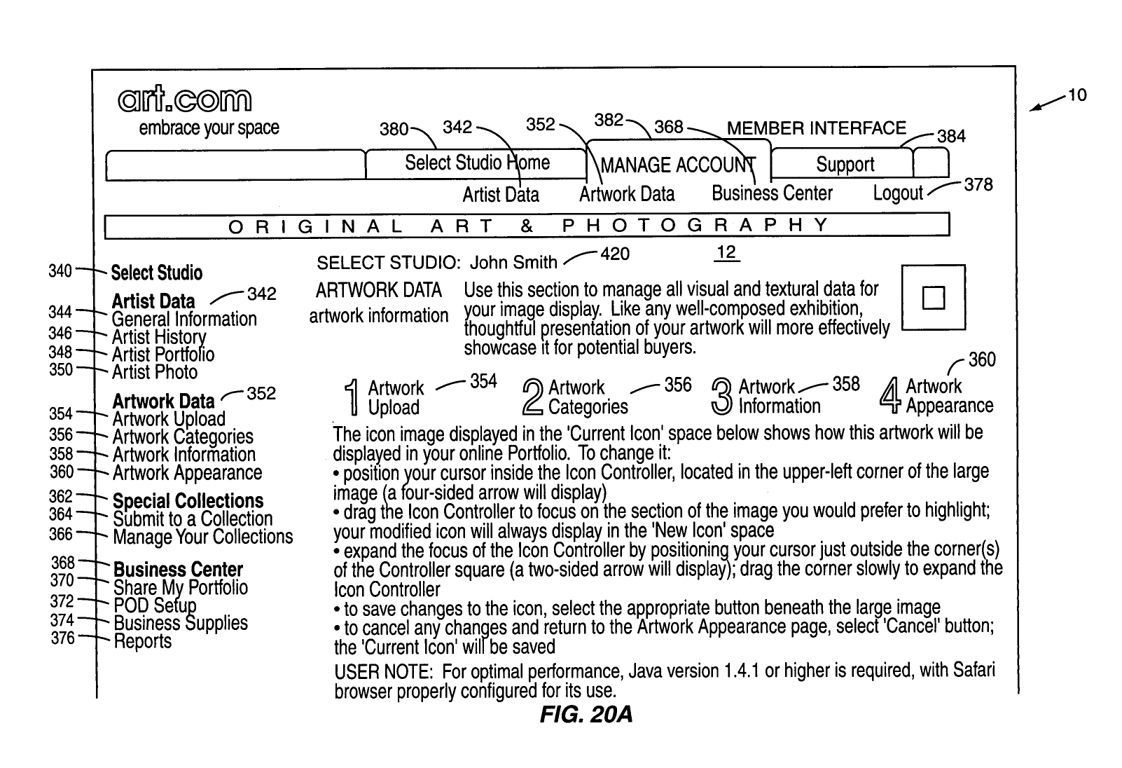

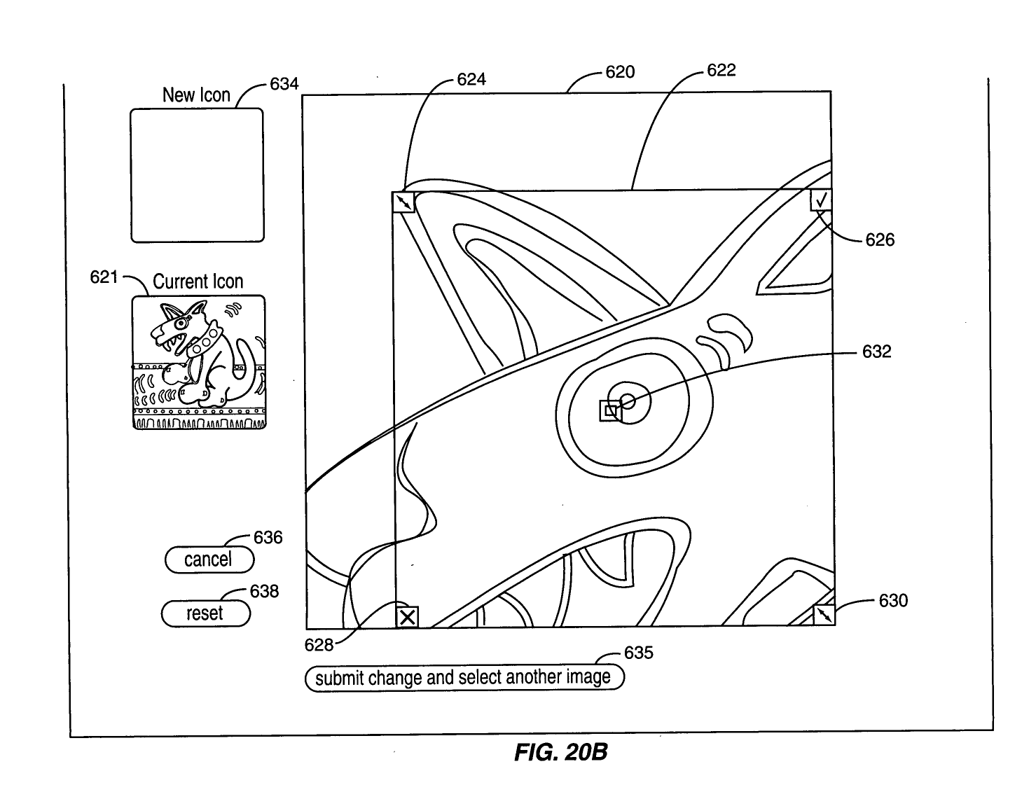

Once the artist clicks on the “edit icon” link 578, a message regarding same is communicated to the Art.com website. The Art.com website receives the request to customize the icon appearance for the artwork selected (step 604 in FIG. 18). Thereafter, the Art.com website prepares a page with the image enlarged and an icon selector to allow the artist to select which portion of the complete image previously uploaded will be used for the icon image 528 for the artwork to be displayed in the artist's portfolio and other users as illustrated in FIGS. 20A and 20B (step 606 in FIG. 18). As illustrated in FIG. 20B, the current icon image 621 being used by the Art.com website to display the artwork is displayed. If the icon image is altered by the artist, the new icon image as altered will be displayed on the page as the new icon 634. The artist can select a portion of the complete image 620 to be used as the icon image by selecting a framing box 622. The framing box 622 can be expanded in the corners by clicking and dragging the corner expanders 624, 626, 628, 630. Clicking and dragging the corner expanders 624, 626, 628, 630 allow the artist to control the size of the framing box 622. When the artist is finished, whatever portion of the image is located inside the framing box 622 will be used as the new icon 634 for displaying an icon image of the artwork on the Art.com website. A center selection box 632 is provided that allows the user to move the framing box 622, but not expand or shrink like can be done with the corner expanders 624, 626, 628, 630.

Once the artist has selected the desired framing box 622, the artist can select the “submit change and select another image” link 635 to replace the current icon image 621 with the new icon image 634 formed by the portion of the image 620 inside the framing box 622. The Art.com website will receive the request and will update the page illustrated in FIGS. 20A and 20B to replace the new icon image 634 with the portion of the image 620 inside the framing box 622 (step 608 in FIG. 18). If the artist desires to reset the new icon 634 to erase and make other selections on the framing box 622, the artist can select the “reset” button 638. If the artist wants to cancel the “Artwork Appearance” function, the artist can select the “cancel” button 636.

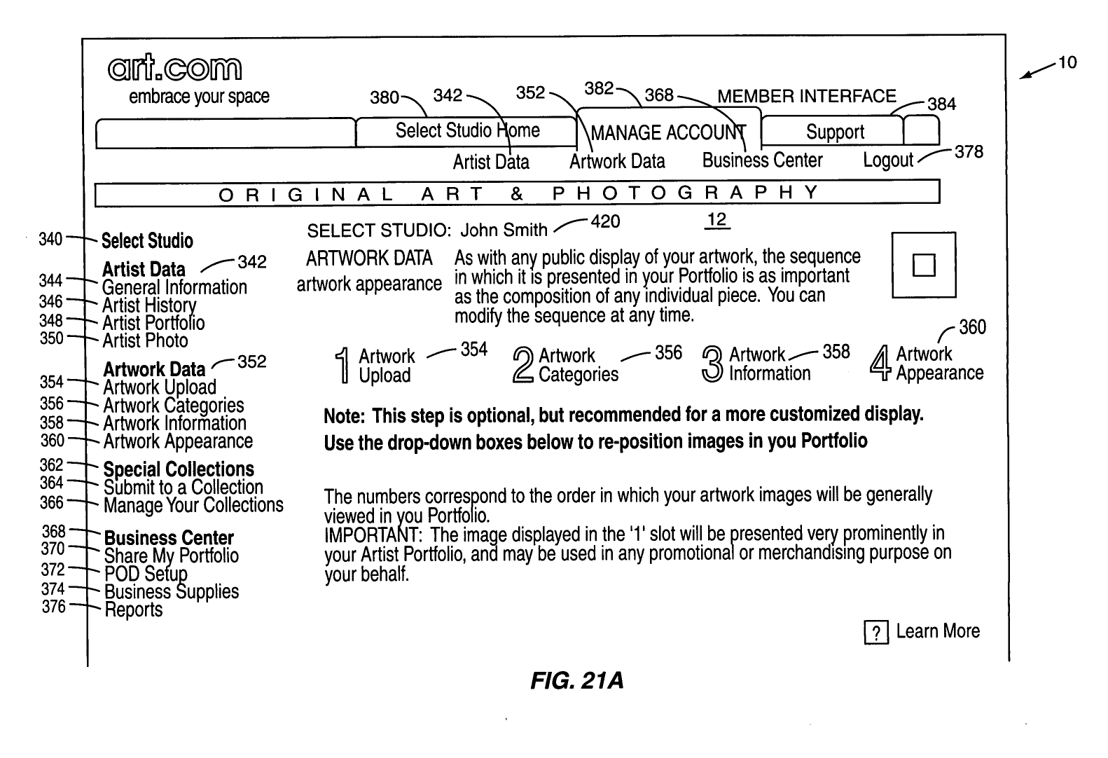

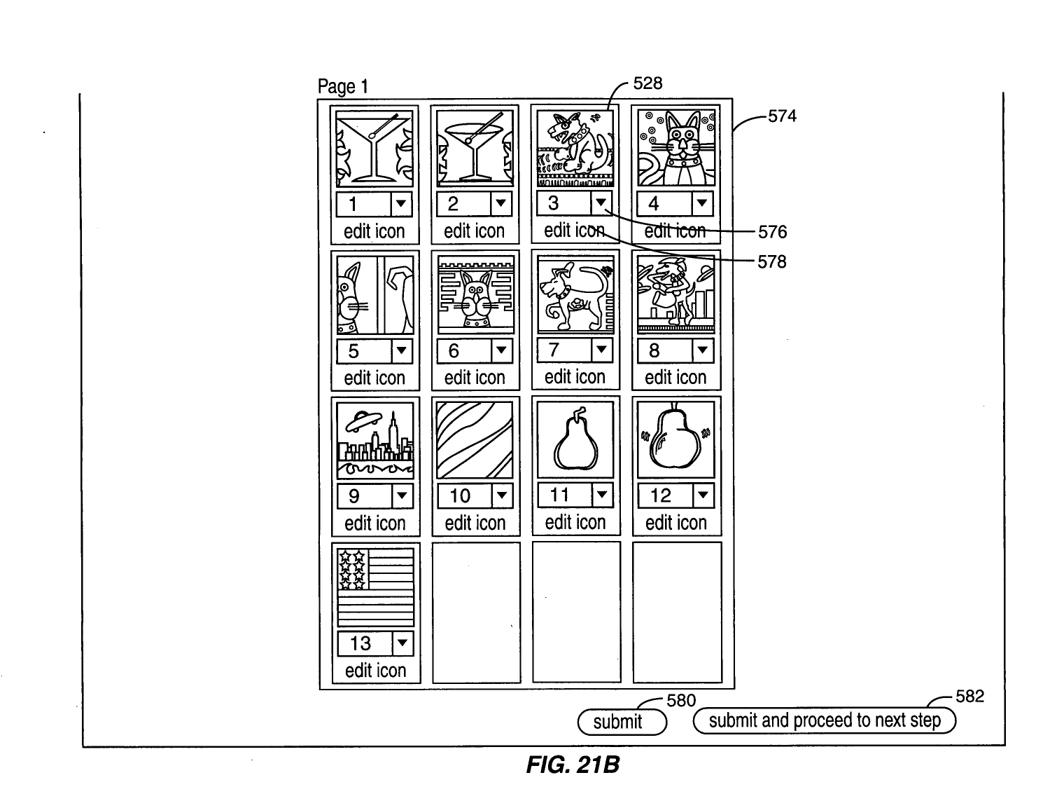

Once the artist selects the “submit change and select another image” link 635, the Art.com website will generate an “Artwork Data” web page to send to the artist's computer 74 to display all artwork icon images in the artist's portfolio for selection of other icons to edit or change ordering number as illustrated on the page in FIGS. 21A and 21B, similar to the page displayed in FIGS. 17A and 17B (step 610 in FIG. 18). The artist can choose to edit another icon image by clicking on an “edit icon” link 578 for the desired icon image to edit, click on the “submit” link 580 to submit ordering changes made, if any, to the Art.com website, or the “submit and proceed to next step” link 582 to submit ordering changes made and return to the “Manage Account” home page, illustrated in FIGS. 20A and 20B.

Print On Demand

At this point, the artist has uploaded artwork images to his or her portfolio, has entered information about the artwork, the artwork may have been approved, and if approved, the artist has possibly altered the appearance of the icon image representing the artwork using the “Artwork Appearance” functionality as described above. If the artist registered the artwork as being for sale and it was approved, other users of the Art.com website can now access the artwork using searching tools previously described to view and/or purchase the original artwork represented by the icon image directly from the artist. However, if the artist also desires to sell high quality reproductions of the original artwork, the artist can register such artwork for POD through the Art.com website, which will make such artwork available for sale as a reproduction directly from Art.com using a POD process rather than through a purchase between the artist and the purchaser/user.

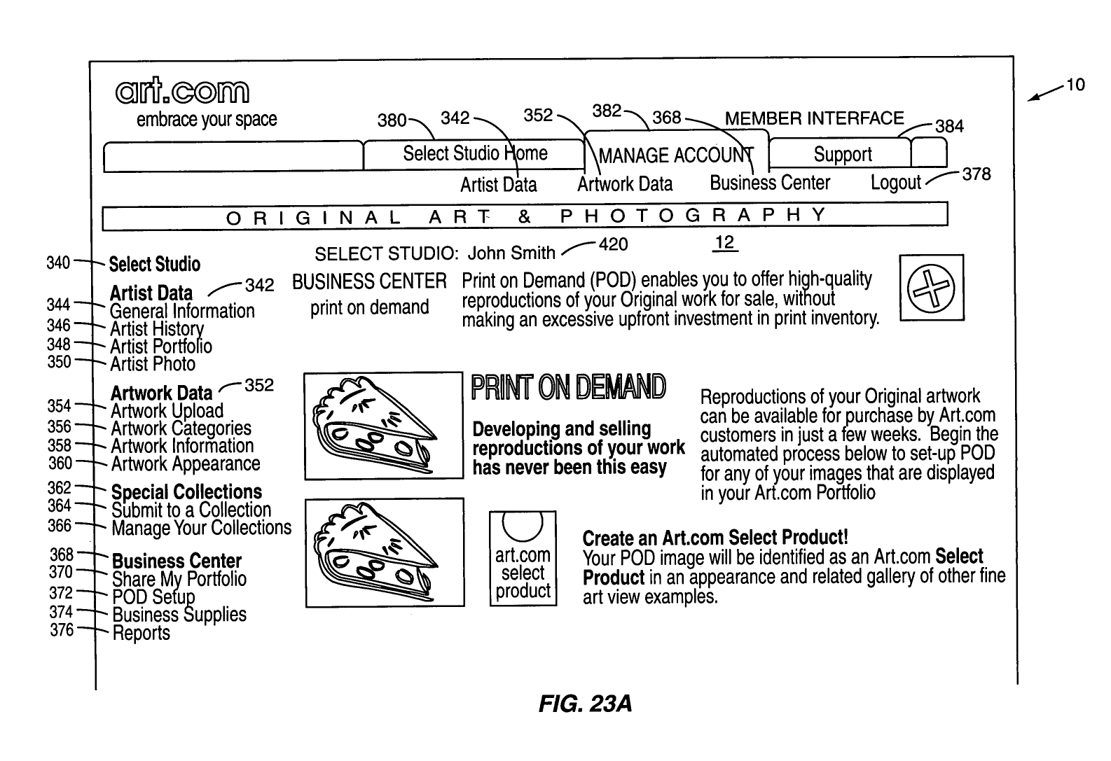

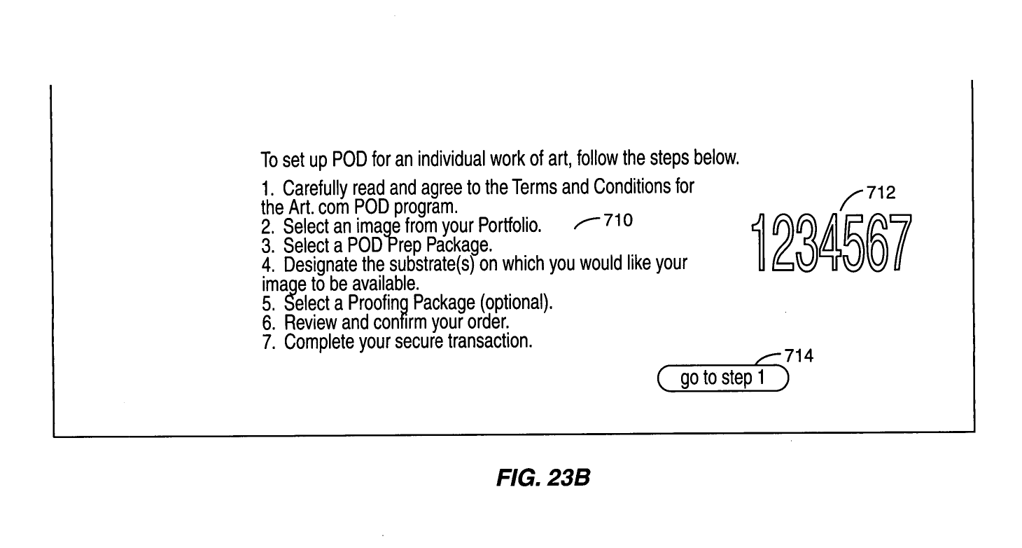

The flowcharts illustrated in FIGS. 22A-22D illustrate the overall process of an artist registering artwork in his or her portfolio in OAP for POD. The process starts by the Art.com website receiving a message from the artist's computer 74 that the artist clicked on the “POD Setup” link 372 in the “Business Center” 368 portion of the OAP section of the Art.com website as illustrated in FIG. 21 (step 650 in FIG. 22). The Art.com website sends the page illustrated in FIGS. 23A and 23B to the artist's computer 74 in response (step 652 in FIG. 22A). The page is the home page of the “Print On Demand” setup within the “Business Center.” FIG. 23B discloses the overview of the steps 710 that are required to select artwork for POD. When the artist is ready to continue, the artist selects the “go to step 1” button 714, in which the Art.com website will receive such selection (step 654 in FIG. 22A).

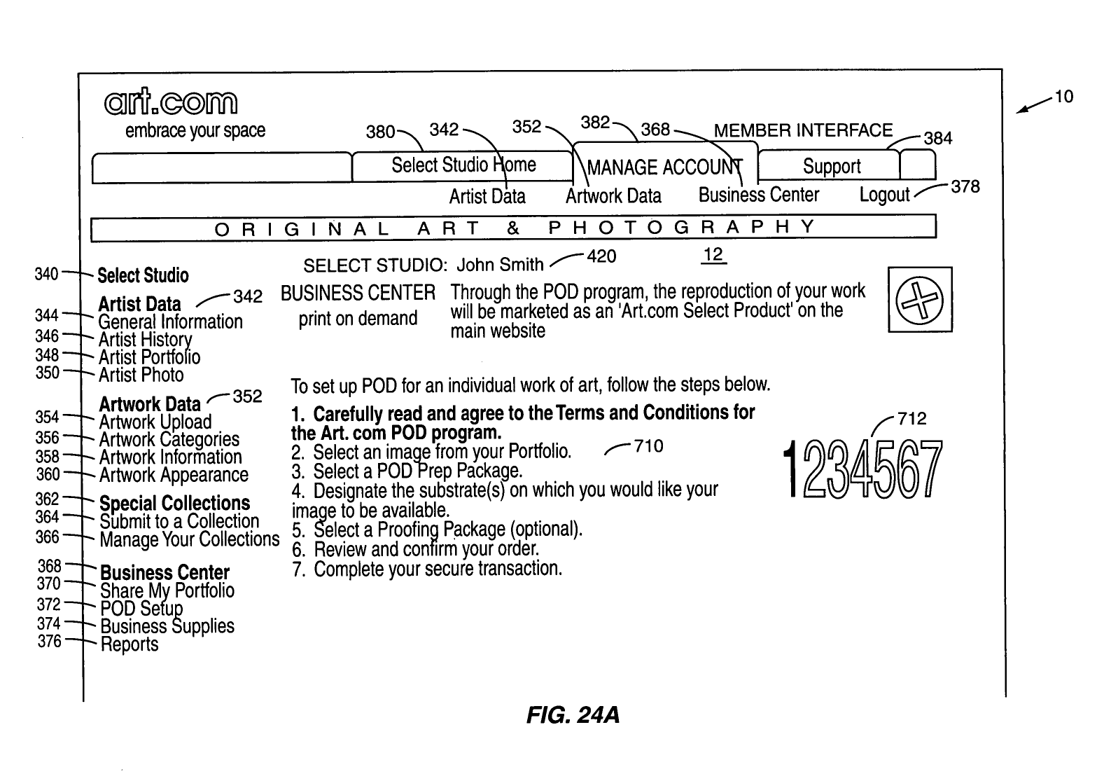

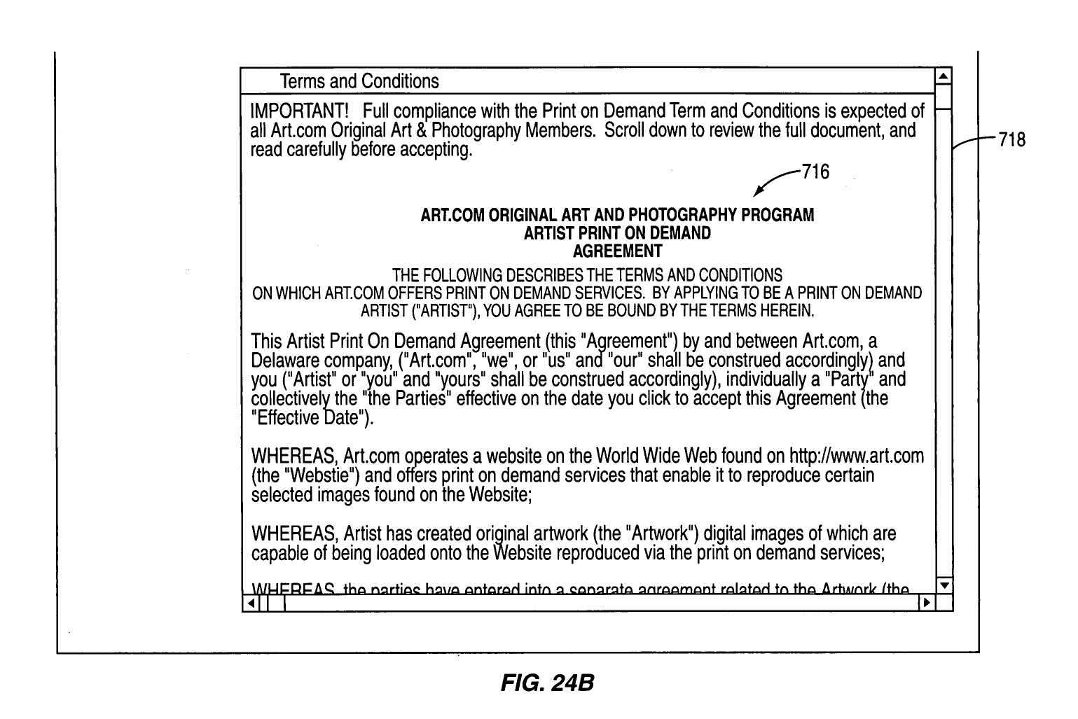

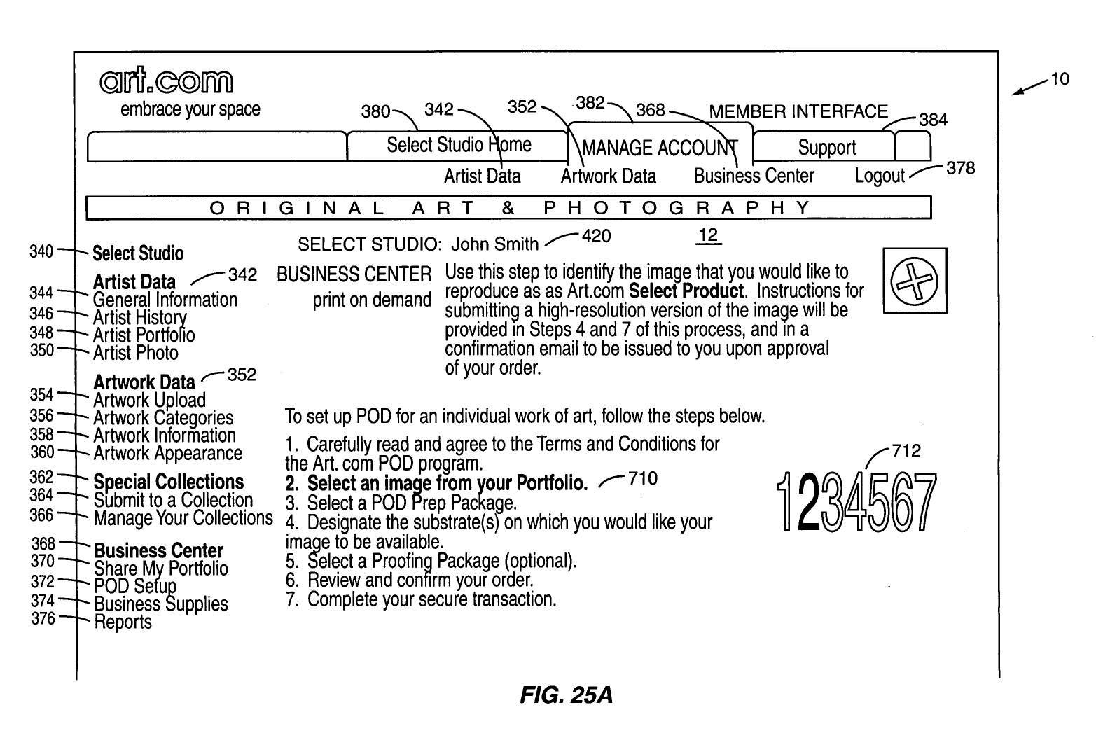

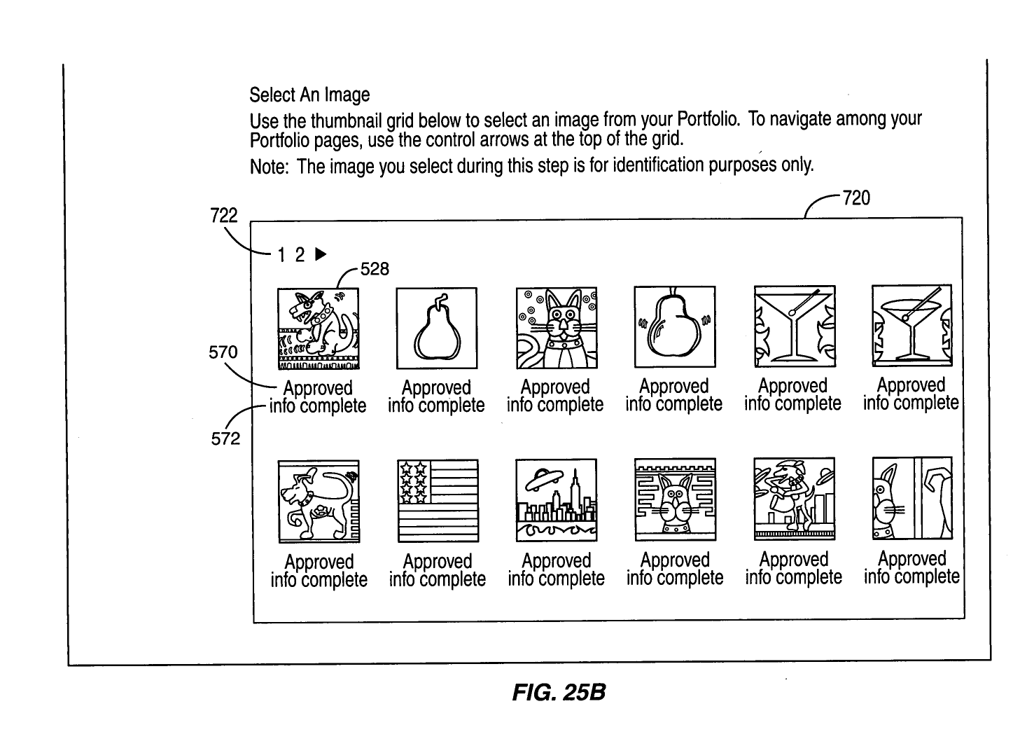

Next, the Art.com website will generate the page illustrated in FIGS. 24A and 24B, which is step 1 of the POD setup process, to send to the artist's computer 74 for display (step 656 in FIG. 22A). The instructions for the page to the artist are shown in the instruction area 710. The current step in the POD process being access is indicated by the highlighted number in the steps area 712. The “Terms and Conditions” to which the artist must agree to in order to continue with the POD setup process are displayed in the text area 716 of a scroll down box 718. If the artist does not accept to the “Terms and Conditions” (decision 658 in FIG. 22A), the Art.com website will not continue on to Step 2 in the POD process. If the artist does not accept the “Terms and Conditions” (decision 658 in FIG. 22A), the artist will scroll down to the bottom of the text area 716 and select a button signifying their agreement (not illustrated) on the page illustrated in FIGS. 24A and 24B, and a message indicating same will be communicated to the Art.com website. Thereafter, the Art.com website will generate a page to be sent to the artist's computer 74 to display the page illustrated in FIGS. 25A and 25B as “Step 2” of the POD setup process for the artist to select an image in the artist's portfolio for POD (step 660 in FIG. 22A).

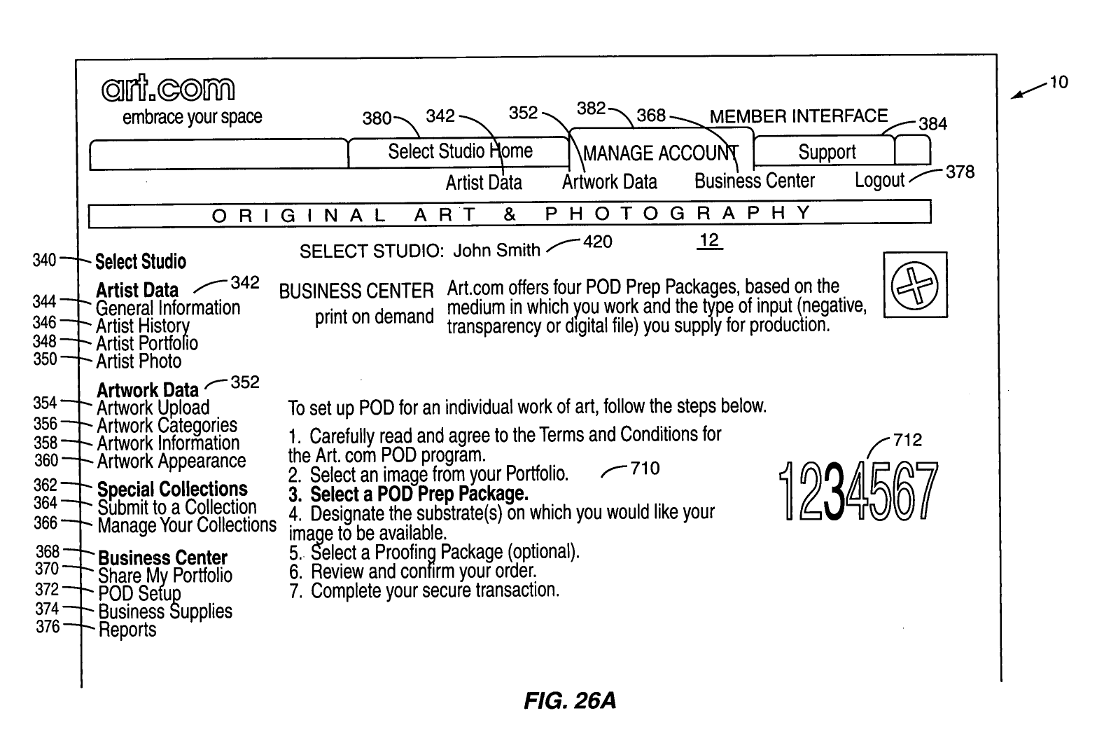

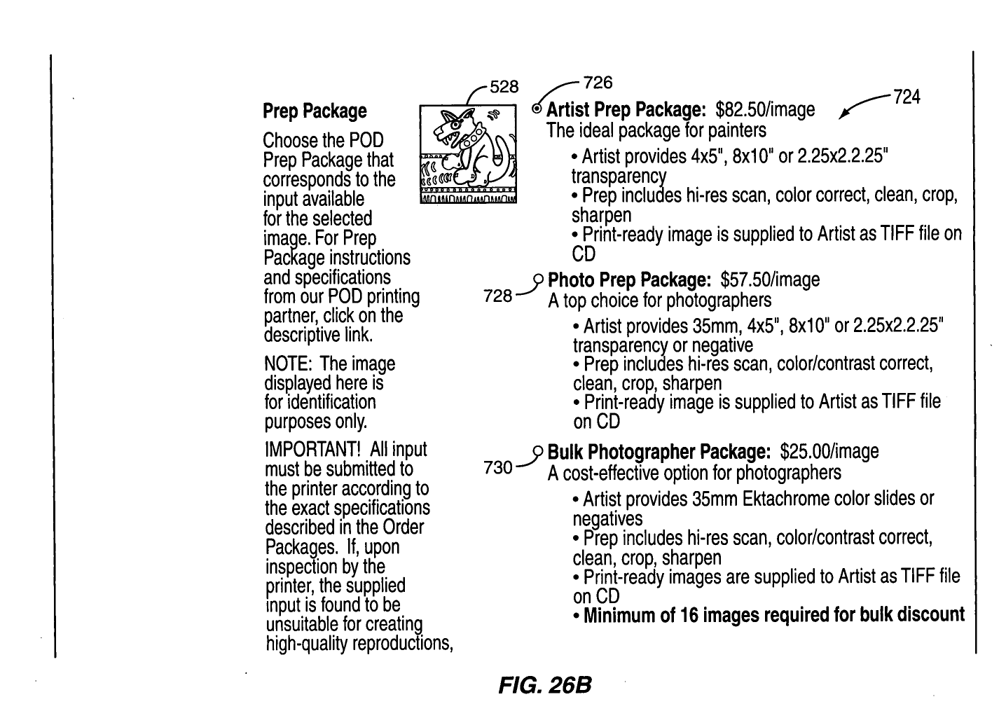

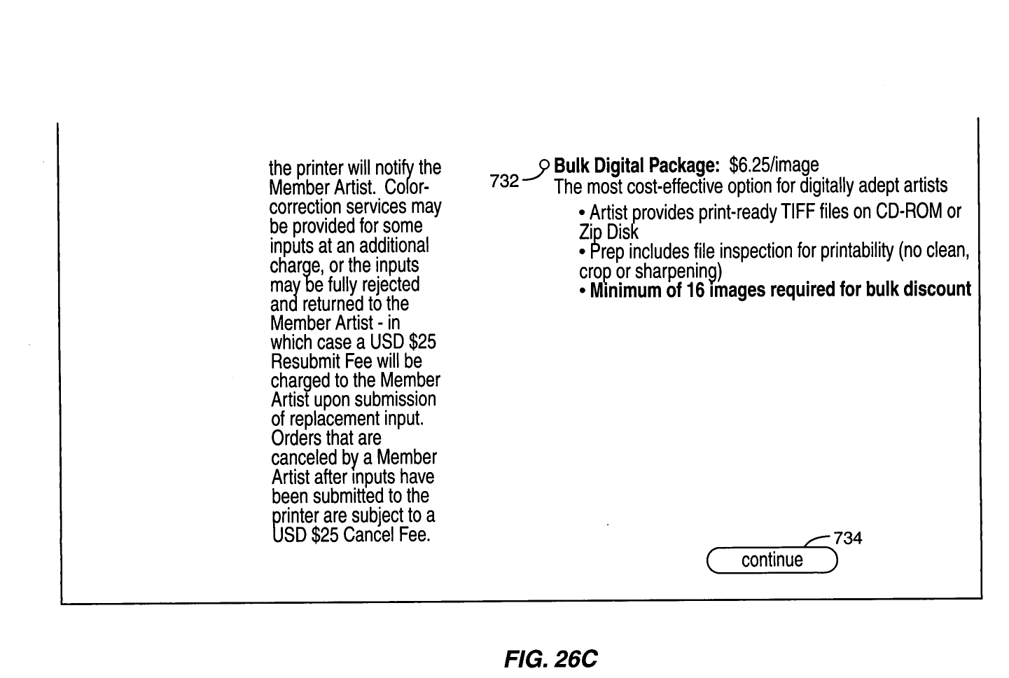

As illustrated in FIGS. 25A and 25B, the artist is now in “Step 2” of the POD setup process which is to “Select an image from your Portfolio” as shown in the instruction areas 710. Each of the works of art in the artist's portfolio is displayed in the artwork area 720. If more artwork is contained in the artist's portfolio that can be displayed in the artwork area 720 at one time, a page link 722 will be displayed to allow the artist to access their artwork not displayed. The artist will next click the artwork desired to setup for POD, which will communicate a message to the Art.com website indicating which artwork is to be setup for POD (step 662 in FIG. 22B). In turn, the Art.com website will generate a page that is displayed in FIGS. 26A-26C to display “Step 3” of the POD setup process to allow an artist to select a “POD Prep Package” for the artwork image selected for POD (step 664 in FIG. 22B).

As illustrated on the page in FIGS. 26B and 26C, there are four different preparation packages called “Prep Packages” that are available for the artist to select. A “Prep Package” contains specifications that must be met and are carried out by the artist in order to generate a print-ready image reproduction of the artwork for making available for sale to other users as reproductions. The four “Prep Packages”: are displayed in the “Prep Package” text area 724, and are the “Artist Prep Package,” the Photo Prep Package,” the “Bulk Photographer Package,” and the “Bulk Digital Package.” A description of each package is contained on the page illustrated in FIGS. 26B and 26C. Buttons beside each preparation package 726, 728, 730, and 732 are available for the artist to click to select the preparation package desired for the POD process for the artwork 528 selected for POD. A charge is also associated with each preparation package as shown in FIGS. 26B and 26C. After the artist selects a button 726, 728, 730, 732 to select the preparation package desired, the artist will select the “continue” button 734 to continue with the POD setup process which will be received by the Art.com website (step 666 in FIG. 22B).

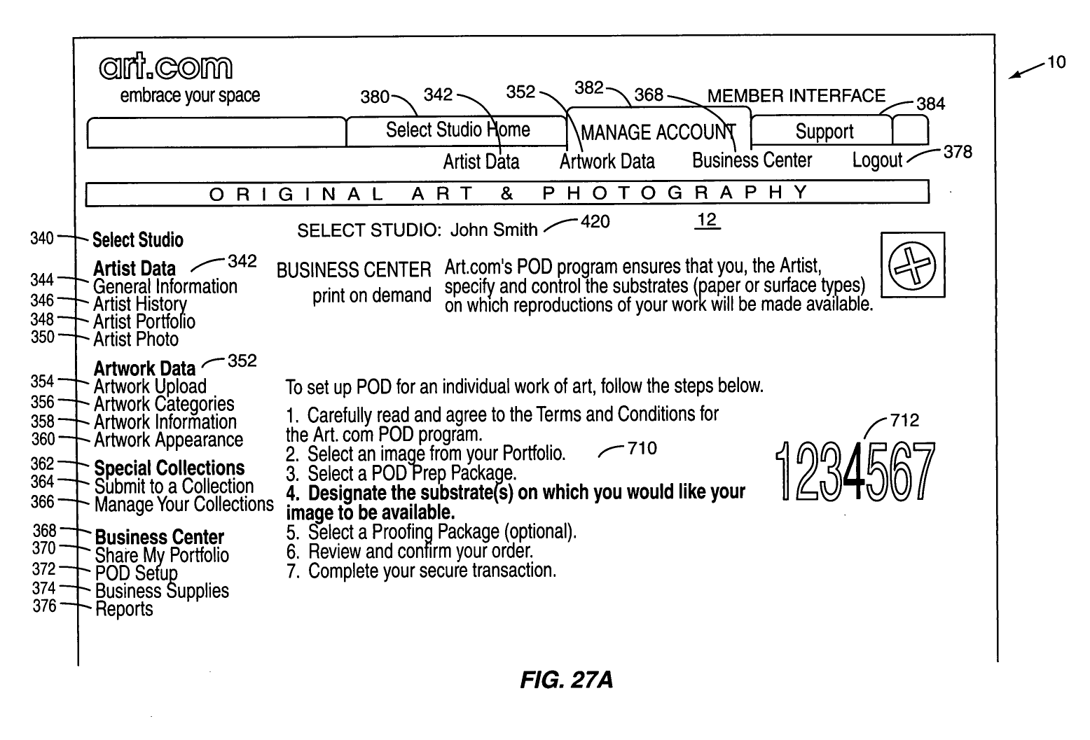

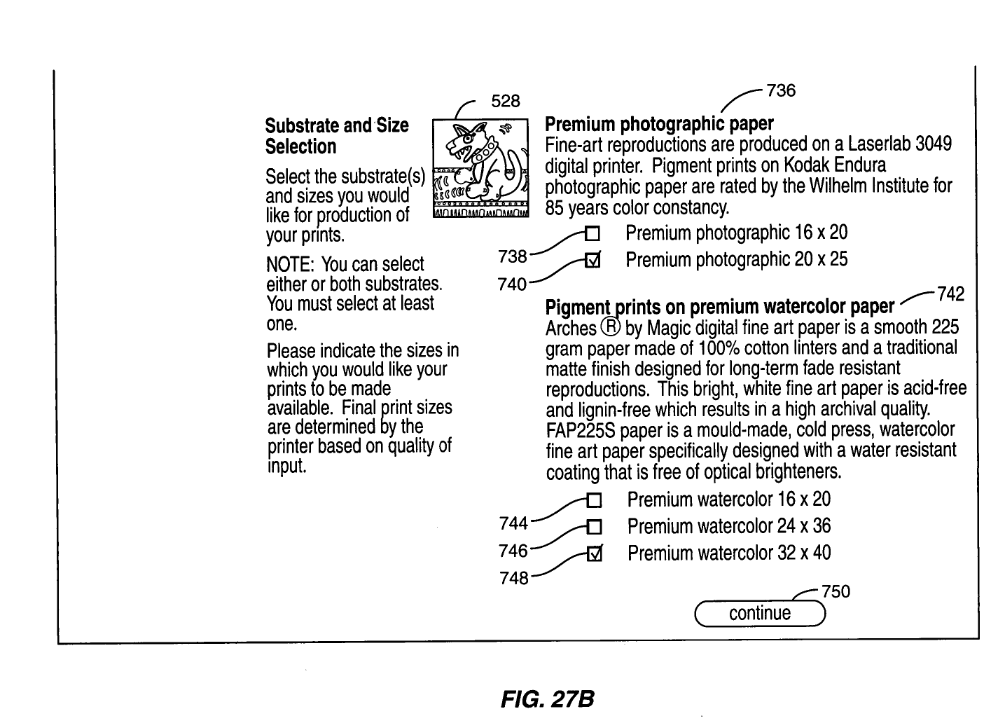

After the Art.com website receives the desired preparation package from the artist, the Art.com website will generate a page illustrated in FIGS. 27A and 27B for “Step 4” of the POD process in order to allow the artist to select the desired substrate for the reproduction of the artwork image that will be generated by the POD process when a purchase of the artwork reproduction is made (step 668 in FIG. 22B). As illustrated in FIG. 27B, selection of the substrate consists of the artist selecting the type and number of substrates that are available for selection by a user purchasing a reproduction of the artwork and thus must be available through POD. The artist can select photographic paper 736 as the substrate by selecting either the “Premium photographic 16×20” paper check box 738 and/or the “Premium photographic 20×25” paper check box 740. Further, if the artist desires to also make the reproduction of the artwork available on watercolor paper in lieu of or in addition to photographic paper, the artist can select one or more check boxes 744, 746, 748 for different sizes illustrated for “Premium watercolor” paper. After the artist is finished selecting the substrate, the artist selects the “continue” button 750 to communicate the substrate choice to the Art.com website.

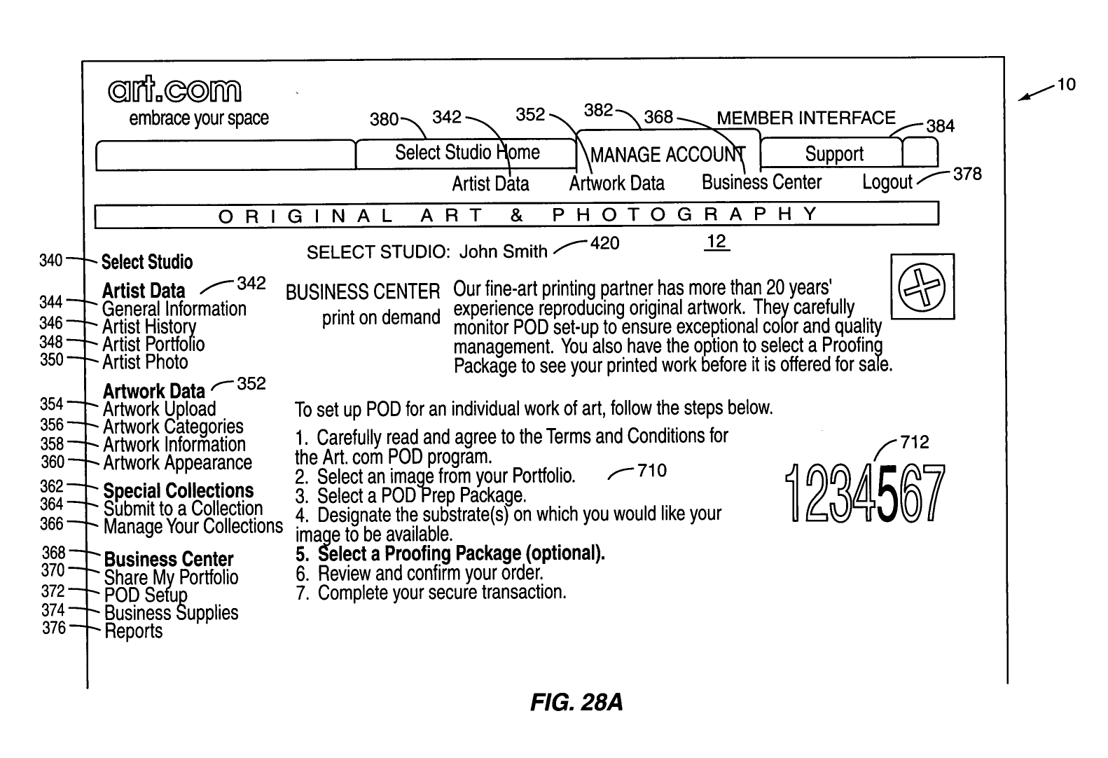

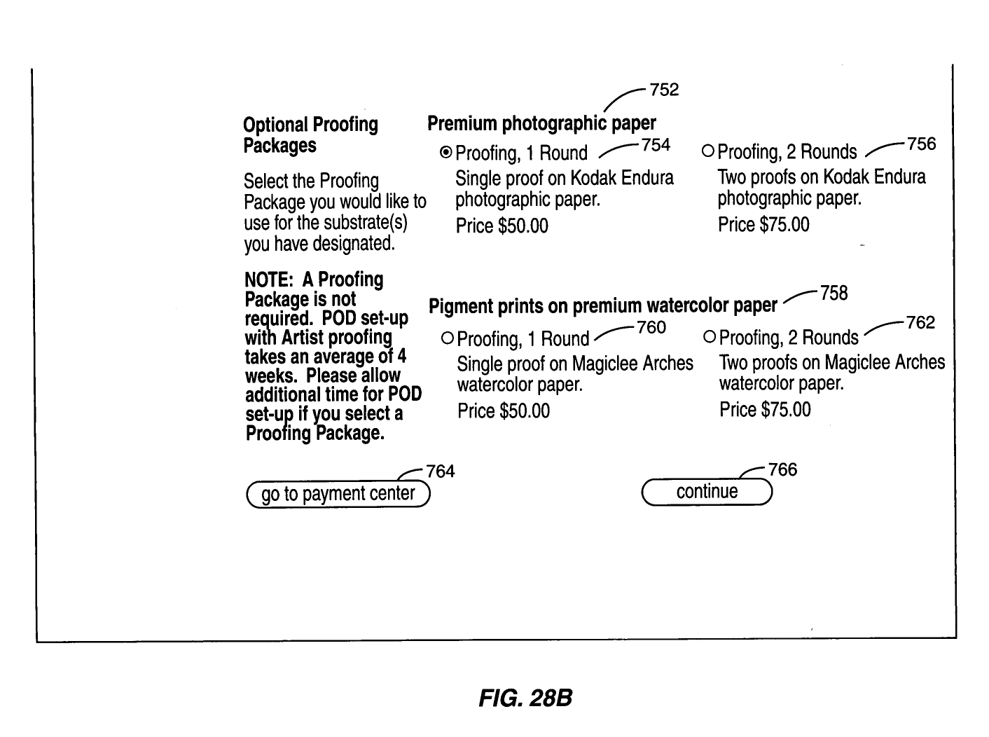

After the Art.com website receives the substrate selection from the artist's computer 74 (step 670 in FIG. 22B), the Art.com website generates and sends a page to the artist's computer 74 to display “Step 5” of the POD setup process (step 672 in FIG. 22B) to allow the artist to select an optional proofing package as illustrated in FIGS. 28A and 28B. As illustrated in FIG. 28B, four proofing packages are available, two for a photographic paper substrate 752, and two for a watercolor paper substrate 758. The artist may select either one or two rounds of proofing by selecting the appropriate buttons 754, 756, 760, 762.

Proofing is an optional step to ensure the ability of the artist to have the opportunity to proof the reproduction of the artwork before the reproduction of the artwork is made available for purchase on the Art.com website. Some artist may want to have the ability to proof the image twice. Next, the artist can select the “continue” button 766 to communicate the proofing package selected to the Art.com website and to go to “Step 6” of the POD setup process to review and confirm the POD order. Alternatively, the artist can select the “go to payment center” button 764 to skip “Step 6” and go straight to “Step 7” to complete the transaction by providing payment. In this exemplary embodiment, payment is required in order for an artist to place a POD order. However, please note that the Art.com website can be configured to reduce and/or waive fees for POD orders in general, or based on the artist's member ID. The Art.com website will check the member's ID to determine if a flag has been set in the “members table” 110 indicating that the artist is not required to pay POD order fees, and if so, Step 7 will be skipped.

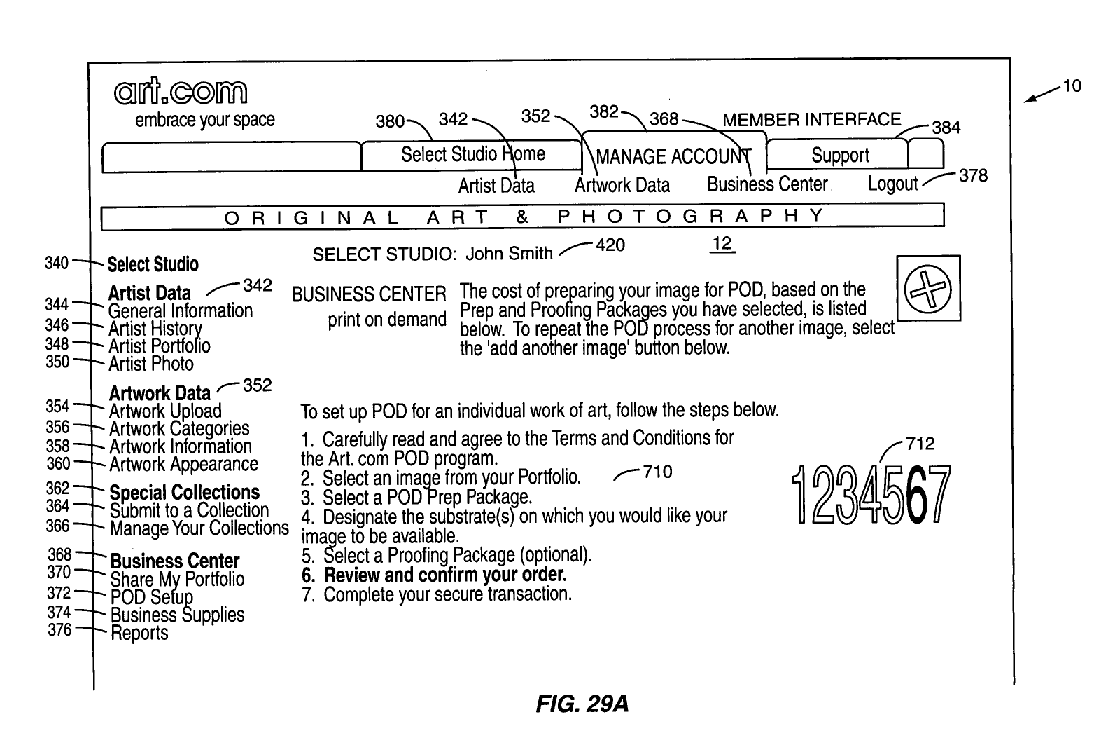

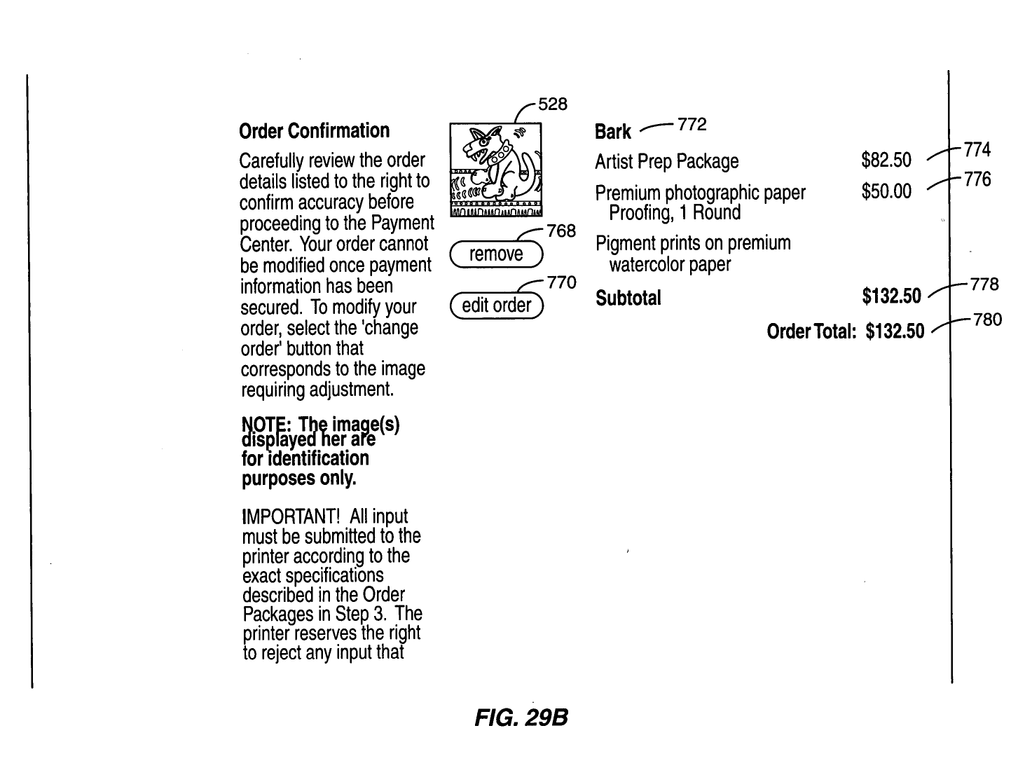

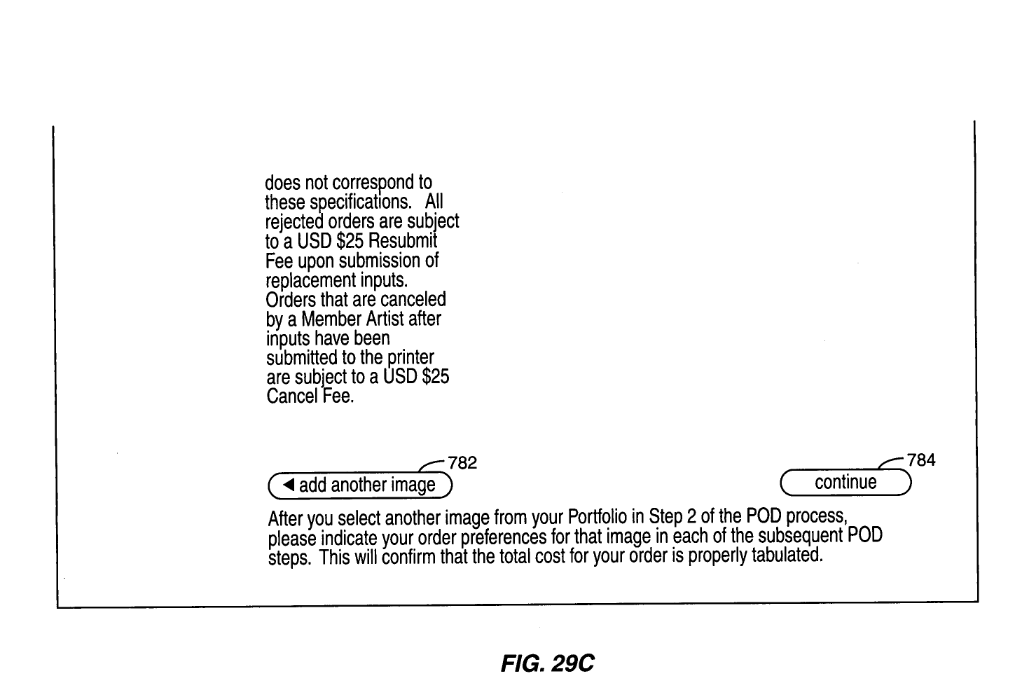

If the artist selects the “continue” button 766 to go to “Step 6,” the Art.com website will receive this indication (step 674 in FIG. 22C), and will prepare a page for “Step 6” to be communicated to the artist's computer 74 as illustrated in FIGS. 29A-29C (step 676 in FIG. 22C). As illustrated in FIG. 29B and 29C, the POD order is displayed for the artist to confirm. The artwork selected for POD 528 is displayed along with its title 772. If a preparation package was selected previously, the type of preparation package is displayed along with the charge associated with such 774. The substrates to be requested are also displayed along with their associated costs 776. Finally, a subtotal 778 for each artwork selected for POD and a order total 780 for the POD order are displayed for the artist to confirm. If the artist desires to select another artwork in their portfolio for POD setup, the artist can select the “add another image” button 782 in FIG. 29C, and the POD setup process will go back to step 2 illustrated in FIGS. 25A and 25B to allow the artist to select another artwork for POD. If the artist selects the “continue” button 784, a message will be communicated to the Art.com website that the artist is ready to proceed to “Step 7” to present payment to finish the POD order displayed in “Step 6” (step 678 in FIG. 22C).

Next, if the artist is required to pay POD fees as discussed above, the Art.com website will generate a page to send to the artist's computer for “Step 7” to allow the artist to provide secure payment for their POD order (step 680 in FIG. 22C, not illustrated as a page). Once the payment is received by the Art.com website (step 682 in FIG. 22C), and is successful (decision 684 in FIG. 22C), the Art.com website will prepare a page to send to the artist that the POD order was successfully confirmed by the Art.com website as illustrated in FIGS. 30A and 30B (step 686 in FIG. 22D). If the artist is not required to pay POD fees, the Art.com website will skip Step 7 (step 680 in FIG. 22C) and will generate the pages illustrated in FIGS. 30A and 30B (step 686 in FIG. 22D).

As illustrated in FIGS. 30A and 30B, the page contains the “Order Information” 786 consisting of the “Image name” 788, the “POD Prep Package” 790, the “Substrate(s)” 792, the “Proof Package(s)” 794, the “Cost” 796, the “Status” 798, and the “Total Cost” 800 for the POD order. Every artwork successfully completed for a POD order request is subject to approval so that the reproduction of the artwork is not made available to other users of the Art.com website until the POD setup and proofing process has been completed.

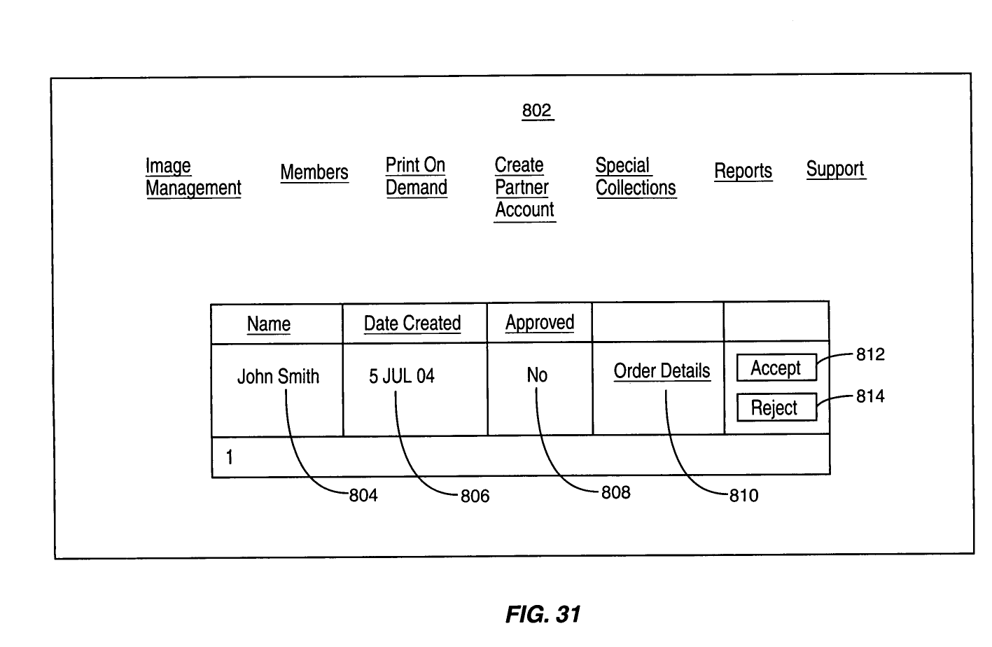

Thereafter, the Art.com website adds the selected artwork images for POD to an image management table queue for approval (step 688 in FIG. 22D). An illustration of the selected artwork images table is illustrated in FIG. 31. In the queue list, the name of the artist 804, the date of the entry in the queue 806, the approval status 808, a link to the “Order Detail” 810, and buttons to allow an administrator of the Art.com POD process to “Accept” 812 or “Reject” 814 the order is available. The queue list is available as a page to administrators of the Art.com website. Thereafter, if the image is approved, the Art.com website will create a “POD PID Number” in the “POD Order Products Table” 116 (illustrated in FIG. 3) so that the artwork contains a product identification number in the Art.com website for tracking purposes (step 690 in FIG. 22D). The artwork selected for POD is next updated in the “Order Management Queue” as being in progress until the artist sends in the necessary information on the artwork to have the artwork finalized for POD (step 692 in FIG. 22D).

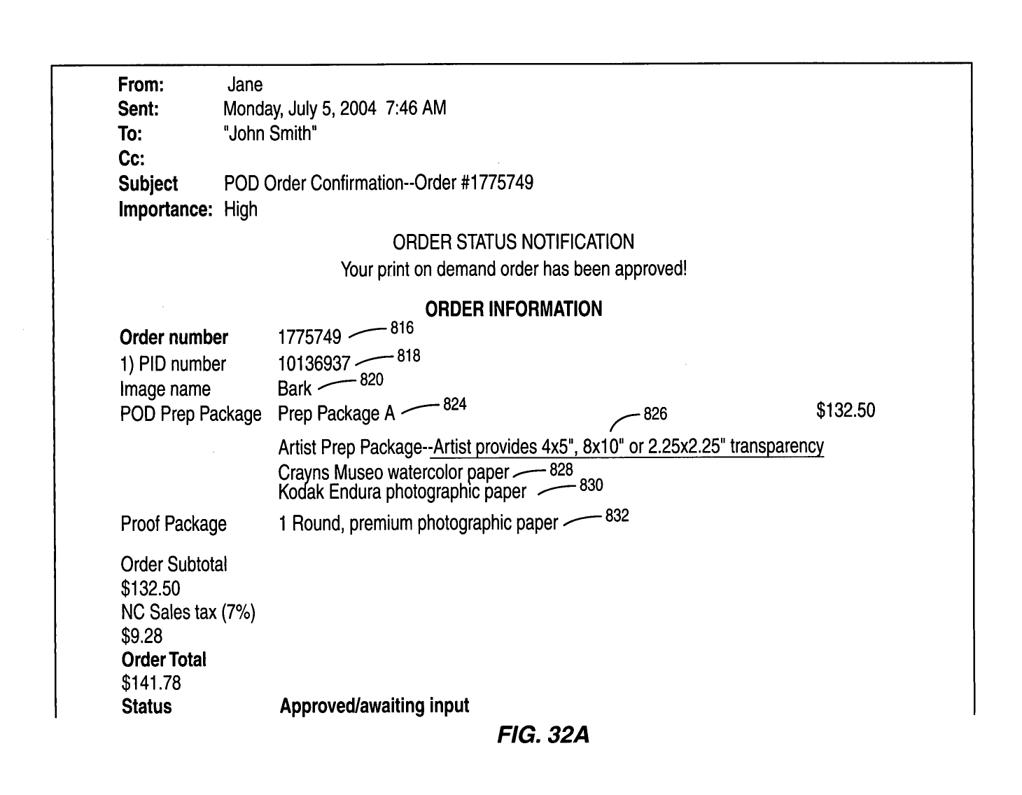

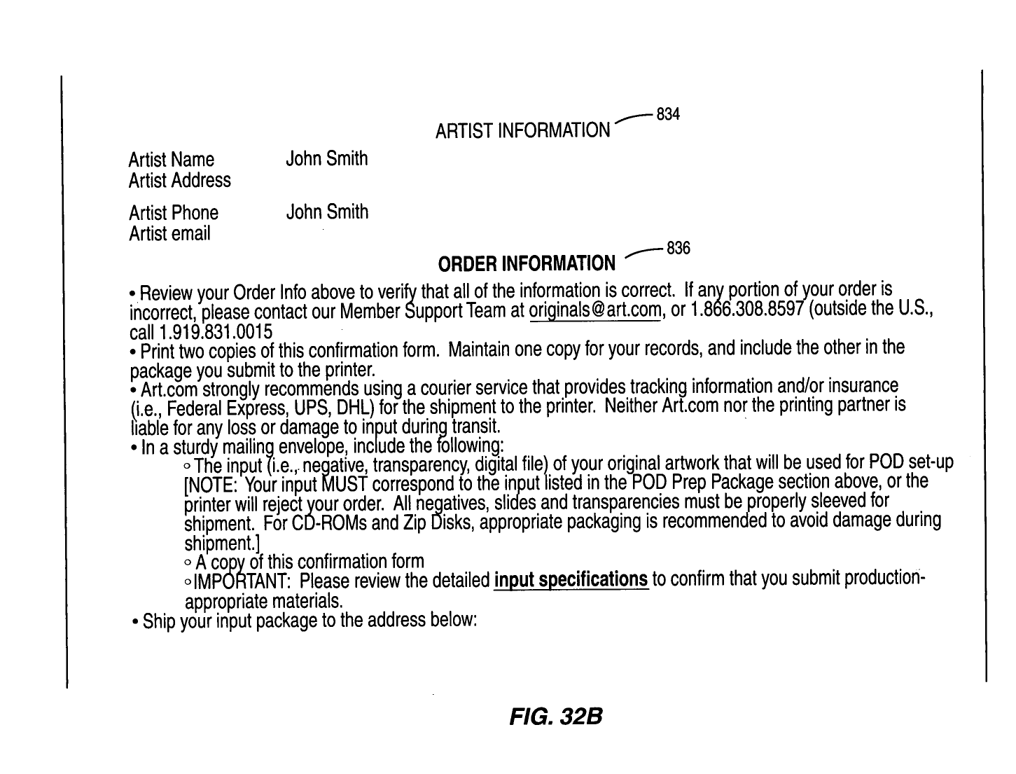

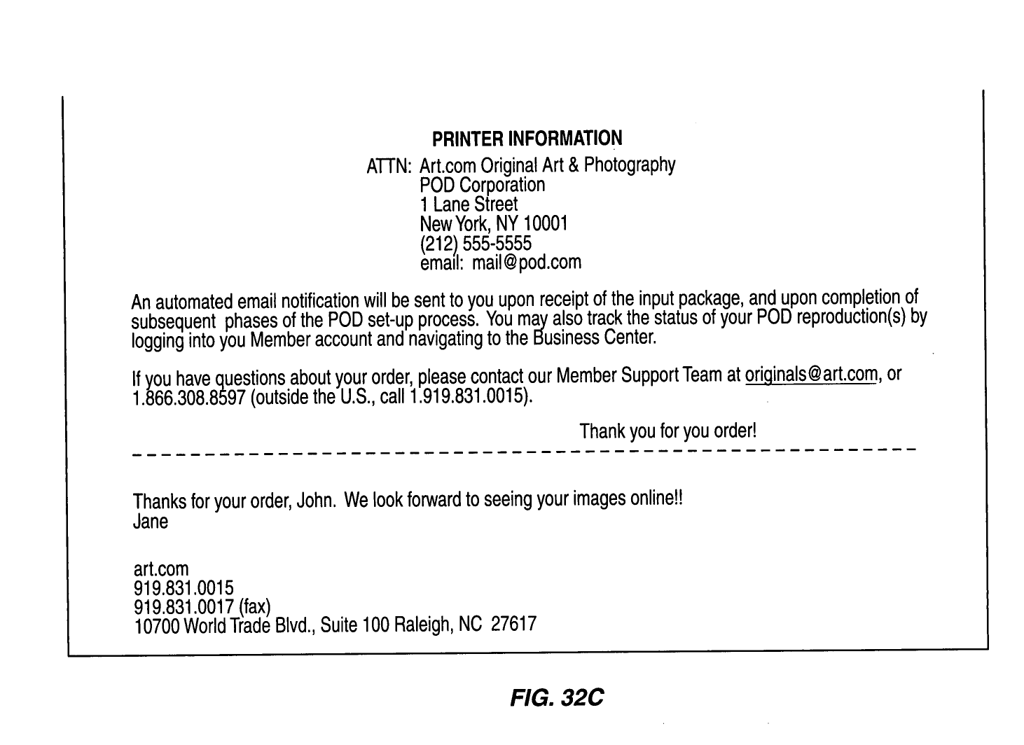

Thereafter, the Art.com website sends an email to the artist with order information for artwork selected for POD stating that the images selected have been approved by Art.com as illustrated in FIGS. 32A-32C (step 694 in FIG. 22D). Turning to FIGS. 32A-32C, the email indicates the “Order number” 816 assigned to the order by the Art.com website, the “PID number” 818, which will be the product ID of the image when offered for sale as a reproduction on the Art.com website, the “Image name” 820, the “POD Prep Package” 824, the instructions on what the artist must provide 826, the substrates 828, 830, and the “Proof Package” 832. The email also contains instructions to the artist in the “Order Information” section 836 (FIG. 32B) on what the artist is to send to the publisher in order to have the artwork selected for POD scanned for proofing by the artist.

Once the proof of the artwork is finally approved by the artist, reproductions of the artwork selected for POD are made available to users of the Art.com website through OAP similar to artwork that is kept in inventory, except that reproductions of artwork purchased are printed when ordered rather than kept on stock in inventory.

Those skilled in the art will recognize improvements and modifications to the preferred embodiments of the present invention. Note that the various steps and processes outlined in this application are in accordance with an exemplary embodiment, and the present invention is not limited to the particular inclusion or exclusion of various steps or procedures. All such improvements and modifications are considered within the scope of the concepts disclosed herein and the claims that follow.

What is claimed is:

1. A method of selecting for printing on demand an electronic image file representative of artwork to be made available for purchase on a website executing on a computer system that is coupled to a communications network wherein the artwork is printed on demand after selection of the electronic image file representing the artwork for purchase, the computer system performing the steps of:
(I) receiving a login request comprising login information from an artist via the website; and
(II) authenticating the login request from the artist by comparing the login information to information in memory associated with the computer system, and if the login request is authenticated, the computer system performing the steps of:
(A) receiving a request from the artist over the communications network to upload an electronic image file representative of artwork onto the computer system into a portfolio associated with the artist in the memory via the website;
(B) receiving one or more transmitted electronic image files from the artist over the communications network;
(C) storing the one or more transmitted electronic image files received over the communications network into the artist's portfolio; and
(D) receiving an approval from an operator of the website that the one or more electronic image files are approved for display and purchase by users of the website, and if the approval is received, the computer system performing the step of:
(i) receiving a request from the artist over the communications network to select artwork represented by the one or more of the transmitted electronic image files in the artist's portfolio for printing on demand when selected for purchase on the website.

2. The method of claim 1, further comprising the step of the computer system after step (i), sending information over the communications network to the artist of the available sizes for printing on demand for the selected artwork represented by the one or more transmitted electronic image files.

3. The method of claim 2, further comprising the step of the computer system receiving a selection from the artist of the desired size of the artwork to be made available to a user for the artwork that is selected for printing on demand.

4. The method of claim 1, further comprising the step of the computer system after step (i), sending information over the communications network to the artist of the available substrates for printing on demand for the selected artwork represented by the one or more transmitted electronic image files.

5. The method of claim 4, further comprising the step of the computer system receiving a selection from the artist of the desired substrate of the artwork to be made available to a user for the artwork that is selected for printing on demand.

6. The method of claim 1, further comprising the step of the computer system after step (i), sending information over the communications network to the artist of the available prep packages for preparation of the printing on demand for the selected artwork represented by the one or more transmitted electronic image files.

7. The method of claim 6, further comprising the step of the computer system receiving a selection from the artist of the desired prep package for preparation of the artwork to be made available to a user for the artwork that is selected for printing on demand.

8. The method of claim 1, further comprising the step of the computer system after step (i), sending information over the communications network to the artist a request for review and confirmation of the selection of printing on demand for the selected artwork represented by the one or more transmitted electronic image files.

9. The method of claim 8, further comprising the step of the computer system receiving confirmation from the artist of the selection of printing on demand for the selected artwork represented by the one or more transmitted electronic image files.

10. The method of claim 9, further comprising the step of the computer system billing the artist's account for the selection of printing on demand for the selected artwork represented by the one or more transmitted electronic image files once the confirmation has been received by the computer system.

11. The method of claim 9, further comprising the steps of the computer system:
determining if the artist's account is to be billed for the selection of printing on demand for the selected artwork represented by the one or more transmitted electronic image files; and
and not billing the artist's account if the artist is not to be billed for the selection of printing on demand for the selected artwork represented by the one or more transmitted electronic image files.

12. The method of claim 9, further comprising the step of the computer system placing the selected artwork represented by the one or more transmitted electronic image files for printing on demand into a queue in memory for approval by the operator of the website.

13. The method of claim 12, further comprising the step of the computer system receiving an approval from the operator of the website that the selected artwork represented by the one or more transmitted electronic image files for printing on demand is approved for display on the website accessed by users.

14. The method of claim 13, further comprising the step of the computer system placing the selected artwork represented by the one or more transmitted electronic image files for printing on demand into a database associated with the computer system for displaying to users of the website.

15. The method of claim 13, further comprising the step of the computer system sending an electronic communication over the communications network to the artist indicating whether or not the selected artwork represented by the one or more transmitted electronic image files for printing on demand was approved.

16. The method of claim 15 wherein the electronic communication sent by the computer system over the communication network to the artist indicating whether or not the selected artwork represented by the one or more transmitted electronic image files for printing on demand was approved is an email.

17. The method of claim 1, further comprising the step of the computer system after step (C) forming a icon for one or more transmitted electronic image files received from the artist over the communications network.

18. The method of claim 17, further comprising storing the icon in the artist's portfolio.

19. The method of claim 18, further comprising the step of the computer system receiving a selection from the artist to modify the appearance of an icon from the icons stored for the one or more transmitted electronic image files.

20. The method of claim 19, further comprising the step of the computer system transmitting the electronic image associated with the icon selected by the artist to modify over the communications network.

21. The method of claim 20, further comprising the step of the computer system receiving a transmission from the artist of a selection of the area of the electronic image associated with the icon to formulate a new icon for the electronic image associated with the icon.

22. The method of claim 21, further comprising the step of the computer system storing in the artist's portfolio the area of the electronic image associated with the icon received over the communications network as a new icon for the electronic image associated with the icon.

23. The method of claim 17, further comprising the step of the computer system transmitting the icon for one or more transmitted electronic image files over the communications network in response to a request by the artist over the communications network to access the artist's portfolio from the computer system.

24. A computer system for receiving electronic image files representative of artwork to be made available for purchase on a website executing on the computer system and making the artwork represented by the electronic image files available for sale to users on a website using a print on demand production, comprising:
a computer system having memory, wherein the computer system executes a website, and wherein the computer system is coupled to a communications network;
wherein the computer system is adapted to:
(I) receive a login request comprising login information from an artist via the website; and
(II) authenticate the login request from the artist by comparing the login information to information in memory associated with the website, and if the login request is authenticated, the computer system further adapted to:
(A) receive a request from the artist over the communications network to upload an electronic image file representative of artwork on to the computer system into a portfolio associated with the artist in the memory via the website;
(B) receive one or more transmitted electronic image files from the artist over the communications network;
(C) store the one or more transmitted electronic image files received over the communications network into the artist's portfolio; and
(D) receive an approval from an operator of the website that the one or more electronic image files are approved for display and purchase by users of the website, and if the approval is received, the computer system further adapted to:
(i) receive a request from the artist over the communications network to select artwork represented by the one or more of the transmitted electronic image files in the artist's portfolio for printing on demand when selected for purchase on the website.

25. The system of claim 24, wherein the computer system is further adapted to send information over the communications network to the artist of the available sizes for printing on demand for the selected artwork represented by the one or more transmitted electronic image files.

26. The system of claim 25, wherein the computer system is further adapted to receive a selection from the artist of the desired size of the artwork to be made available to a user for the artwork that is selected for printing on demand.

27. The system of claim 24, wherein the computer system is further adapted to send information over the communications network to the artist of the available substrates for printing on demand for the selected artwork represented by the one or more transmitted electronic image files.

28. The system of claim 27, wherein the computer system is further adapted to receive a selection from the artist of the desired substrate of the artwork to be made available to a user for the artwork that is selected for printing on demand.

29. The system of claim 24, wherein the computer system is further adapted to send information over the communications network to the artist of the available prep packages for preparation of the printing on demand for the selected artwork represented by the one or more transmitted electronic image files.

30. The system of claim 29, wherein the computer system is further adapted to receive a selection from the artist of the desired prep package for preparation of the artwork to be made available to a user for the artwork that is selected for printing on demand.

31. The system of claim 24, wherein the computer system is further adapted to send information over the communications network to the artist a request for review and confirmation of the selection of printing on demand for the selected artwork represented by the one or more transmitted electronic image files.

32. The system of claim 31, wherein the computer system is further adapted to receive confirmation from the artist of the selection of printing on demand for the selected artwork represented by the one or more transmitted electronic image files.

33. The system of claim 32, wherein the computer system is further adapted to bill the artist's account for the selection of printing on demand for the selected artwork represented by the one or more transmitted electronic image files once the confirmation has been received by the computer system.

34. The system of claim 32, wherein the computer system is further adapted to:
determine if the artist's account is to be billed for the selection of printing on demand for the selected artwork represented by the one or more transmitted electronic image files; and
and not bill the artist's account if the artist is not to be billed for the selection of printing on demand for the selected artwork represented by the one or more transmitted electronic image files.

35. The system of claim 32, wherein the computer system is further adapted to store the selected artwork represented by the one or more transmitted electronic image files for printing on demand into a queue in memory for approval by the operator of the website.

36. The system of claim 35, wherein the computer system is further adapted to receive an approval from the operator of the website that the selected artwork represented by the one or more transmitted electronic image files for printing on demand is approved for display on the website accessed by users.

37. The system of claim 36, wherein the computer system is further adapted to store the selected artwork represented by the one or more transmitted electronic image files for printing on demand into a database associated with the computer system for displaying to users of the website.

38. The system of claim 36, wherein the computer system is further adapted to send an electronic communication over the communications network to the artist indicating whether or not the selected artwork represented by the one or more transmitted electronic image files for printing on demand was approved.

39. The system of claim 38, wherein the electronic communication sent by the computer system over the communications network to the artist indicating whether or not the selected artwork represented by the one or more transmitted electronic image files for printing on demand was approved is an email.

40. The system of claim 24, wherein the computer system is further adapted to form an icon for one or more transmitted electronic image files received from the artist over the communications network.

41. The system of claim 40, wherein the computer system is further adapted to store the icon in the artist's portfolio.

42. The system of claim 41, wherein the computer system is further adapted to receive a selection from the artist to modify the appearance of an icon from the icons stored for the one or more transmitted electronic image files.

43. The system of claim 42, wherein the computer system is further adapted to transmit the electronic image associated with the icon selected by the artist to modify over the communications network.

44. The system of claim 43, wherein the computer system is further adapted to receive a transmission from the artist of a selection of the area of the electronic image associated with the icon to formulate a new icon for the electronic image associated with the icon.

45. The system of claim 44, wherein the computer system is further adapted to store in the artist's portfolio the area of the electronic image associated with the icon received over the communications network as a new icon for the electronic image associated with the icon.

46. The system of claim 40, wherein the computer system is further adapted to transmit the icon for one or more transmitted electronic image files over the communications network in response to a request by the artist over the communications network to access the artist's portfolio from the computer system.
